(19) United States
(12) Patent Application Publication
(10) Pub. No.: US 2025/0259017 A1
(43) Pub. Date: Aug. 14, 2025

(54) INFORMATION PROCESSING APPARATUS, INFORMATION PROCESSING METHOD, AND STORAGE MEDIUM

(71) Applicant: NEC Corporation, Tokyo (JP)

(72) Inventors: Eiji KANEKO, Tokyo (JP); Keisuke KANEYASU, Tokyo (JP); Masahiko TANGE, Tokyo (JP); Shota ONO, Tokyo (JP); Tadaharu TAKAHASHI, Tokyo (JP)

(73) Assignee: NEC Corporation, Tokyo (JP)

(21) Appl. No.: 19/044,701

(22) Filed: Feb. 4, 2025

(30) Foreign Application Priority Data
Feb. 13, 2024 (JP) 2024-019528

(51) Int. Cl. G06F 40/40

(52) U.S. Cl. CPC G06F 40/40

(57) ABSTRACT

At least one processor included in an information processing apparatus carries out: an acquisition process for acquiring input information; a derivation process for deriving at least one selected from the group consisting of a first response time, which is required for a first language model to generate first response information, and a second response time, which is required for a second language model to generate second response information; and a determination process for determining response content with respect to the input information with reference to the at least one selected from the group consisting of the first response time and the second response time which has been derived in the derivation process.

This Nonprovisional application claims priority under 35 U.S.C. § 119 on Patent Application No. 2024-019528 filed in Japan on Feb. 13, 2024, the entire contents of which are hereby incorporated by reference.

### TECHNICAL FIELD

The present disclosure relates to an information processing apparatus, an information processing method, and a storage medium.

### BACKGROUND ART

An apparatus for having a conversation with a user is known. For example, Patent Literature 1 discloses a conversation apparatus that selects a response selection model on the basis of a response scene. In the conversation apparatus described in Patent Literature 1, on the basis of a conversation feature based on a conversation with a user, an early period and a final period of a conversation assumption time are determined to be a greeting scene, and the other period is determined to be a conversation scene.

### CITATION LIST

### Patent Literature

### Patent Literature 1

Japanese Patent Application Publication Tokukai No. 2018-124432

### SUMMARY OF INVENTION

### Technical Problem

However, in the conversation apparatus described in Patent Literature 1, it is not assumed to naturally have a conversation with a user in the conversation scene. Therefore, there is a problem that a conversation with the user becomes unnatural.

The present disclosure has been made in view of the above problem, and an example object of the present disclosure is to provide a technique of being capable of naturally having a conversation with a user.

### Solution to Problem

An information processing apparatus in accordance with an example aspect of the present disclosure includes at least one processor, the at least one processor carrying out: an acquisition process for acquiring input information; a derivation process for deriving at least one selected from the group consisting of a first response time, which is required for a first language model to generate first response information in a case where content indicated by the input information is input into the first language model, and a second response time, which is required for a second language model to generate second response information in a case where the content indicated by the input information is input into the second language model; and a determination process for determining response content with respect to the input information with reference to the at least one selected from the group consisting of the first response time and the second response time which has been derived in the derivation process.

An information processing method in accordance with an example aspect of the present disclosure includes: an acquisition process for at least one processor acquiring input information; a derivation process for the at least one processor deriving at least one selected from the group consisting of a first response time, which is required for a first language model to generate first response information in a case where content indicated by the input information is input into the first language model, and a second response time, which is required for a second language model to generate second response information in a case where the content indicated by the input information is input into the second language model; and a determination process for the at least one processor determining response content with respect to the input information with reference to the at least one selected from the group consisting of the first response time and the second response time which has been derived in the derivation process.

A storage medium in accordance with an example aspect of the present disclosure is a non-transitory storage medium storing a program for causing a computer to function as an information processing apparatus, the program causing the computer to carry out: an acquisition process for acquiring input information; a derivation process for deriving at least one selected 1 from the group consisting of a first response time, which is required for a first language model to generate first response information in a case where content indicated by the input information is input into the first language model, and a second response time, which is required for a second language model to generate second response information in a case where the content indicated by the input information is input into the second language model; and a determination process for determining response content with respect to the input information with reference to the at least one selected from the group consisting of the first response time and the second response time which has been derived in the derivation process.

### Advantageous Effects of Invention

An example aspect of the present disclosure brings about an example effect of making it possible to provide a technique of being capable of naturally having a conversation with a user.

### BRIEF DESCRIPTION OF DRAWINGS

FIG. 1 is a block diagram illustrating a configuration of an information processing apparatus in accordance with the present disclosure.

FIG. 2 is a flowchart illustrating a flow of an information processing method in accordance with the present disclosure.

FIG. 3 is a view illustrating an overview of an example of a process carried out by the information processing apparatus in accordance with the present

### DISCLOSURE

FIG. 4 is a block diagram illustrating a configuration of an information processing apparatus in accordance with the present disclosure.

FIG. 5 is a flowchart illustrating a flow of an information processing method in accordance with the present disclosure.

FIG. 6 is a block diagram illustrating a configuration of an information processing apparatus in accordance with the present disclosure.

FIG. 7 is a flowchart illustrating a flow of an information processing method in accordance with the present disclosure.

FIG. 8 is a block diagram illustrating a configuration of an information processing apparatus in accordance with the present disclosure.

FIG. 9 is a flowchart illustrating a flow of an information processing method in accordance with the present disclosure.

FIG. 10 is a block diagram illustrating a configuration of an information processing apparatus in accordance with the present disclosure.

FIG. 11 is a flowchart illustrating a flow of an information processing method in accordance with the present disclosure.

FIG. 12 is a block diagram illustrating a configuration of an information processing apparatus in accordance with the present disclosure.

FIG. 13 is a flowchart illustrating a flow of an information processing method in accordance with the present disclosure.

FIG. 14 is a block diagram illustrating a configuration of a computer that functions as an information processing apparatus in accordance with the present disclosure.

### DESCRIPTION OF EMBODIMENTS

The example embodiments of the present invention will be exemplified in the following description. It should be noted that the present invention is not limited to the example embodiments described below, but may be altered in various ways by a skilled person within the scope of the claims. For example, any example embodiment derived by appropriately combining technical means employed in the example embodiments described below can also be within the scope of the present invention. Further, any example embodiment derived from appropriately omitting some of the technical means employed in the example embodiments described below can also be within the scope of the present invention. Furthermore, an example advantage to which reference is made in each of the example embodiments described below is an example of the advantage expected in that example embodiment, and does not define the extension of the present invention. Therefore, any example embodiment which does not provide the example advantage to which reference is made in each of the example embodiments described below can also be within the scope of the present invention.

### First Example Embodiment

A first example embodiment which is an example of an embodiment of the present invention will be described in detail with reference to the drawings. The present example embodiment is a basic form of each example embodiment described later. The scope of the application of each technical means employed in the present example embodiment is not limited to the present example embodiment. That is, each technical means employed in the present example embodiment can also be employed in other example embodiments included in the present disclosure to the extent that no particular technical obstruction occurs. In addition, each technical means illustrated in the drawings which are referred to for the description of the present example embodiment can also be employed in other example embodiments included in the present disclosure to the extent that no particular technical obstruction occurs.

### (Configuration of Information Processing Apparatus 1)

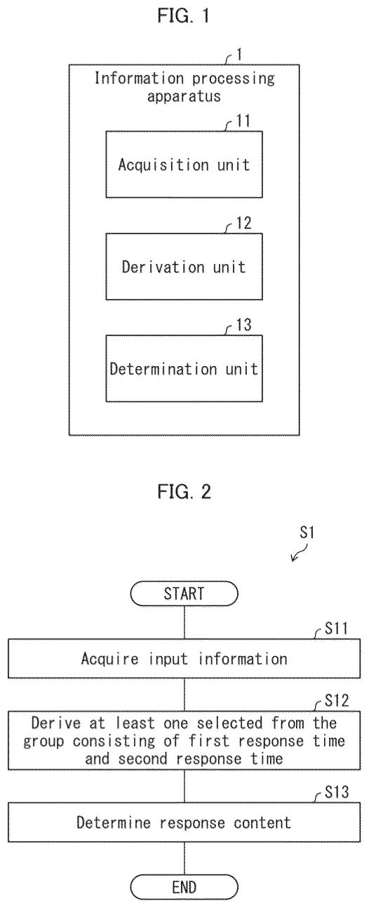

A configuration of an information processing apparatus 1 will be described with reference to FIG. 1. FIG. 1 is a block diagram illustrating the configuration of the information processing apparatus 1. The information processing apparatus 1 includes an acquisition unit 11, a derivation unit 12, and a determination unit 13, as illustrated in FIG. 1. The acquisition unit 11, the derivation unit 12, and the determination unit 13 realize an acquisition means, a derivation means, and a determination means, respectively, in the present example embodiment.

The acquisition unit 11 acquires input information. The acquisition unit 11 supplies the acquired input information to the derivation unit 12 and the determination unit 13.

The derivation unit 12 derives at least one selected from the group consisting of a first response time, which is required for a first language model to generate first response information in a case where content indicated by the input information is input into the first language model, and a second response time, which is required for a second language model to generate second response information in a case where the content indicated by the input information is input into the second language model. The derivation unit 12 supplies, to the determination unit 13, the derived at least one selected from the group consisting of the first response time and the second response time.

The phrase “in a case where the content indicated by the input information is input into the first language model (second language model)” includes a case where the content indicated by the input information is actually input into the first language model and a case where the content indicated by the input information is not actually input into the first language model, but it is assumed that the content indicated by the input information is input into the first language model, prior to the input of the content indicated by the input information.

The determination unit 13 determines response content with respect to the input information with reference to the at least one selected from the group consisting of the first response time and the second response time which has been derived by the derivation unit 12.

### (Effect of Information Processing Apparatus 1)

As described above, in the information processing apparatus 1, a configuration is employed in which the information processing apparatus 1 includes: the acquisition unit 11 that acquires input information; the derivation unit 12 that derives at least one selected from the group consisting of a first response time, which is required for a first language model to generate first response information in a case where content indicated by the input information is input into the first language model, and a second response time, which is required for a second language model to generate second response information in a case where the content indicated by the input information is input into the second language model; and the determination unit 13 that determines response content with respect to the input information with reference to the at least one selected from the group consisting of the first response time and the second response time which has been derived by the derivation unit 12.

Thus, according to the information processing apparatus 1, the effect of being capable of naturally having a conversation with a user is obtained.

### (Flow of Information Processing Method S1)

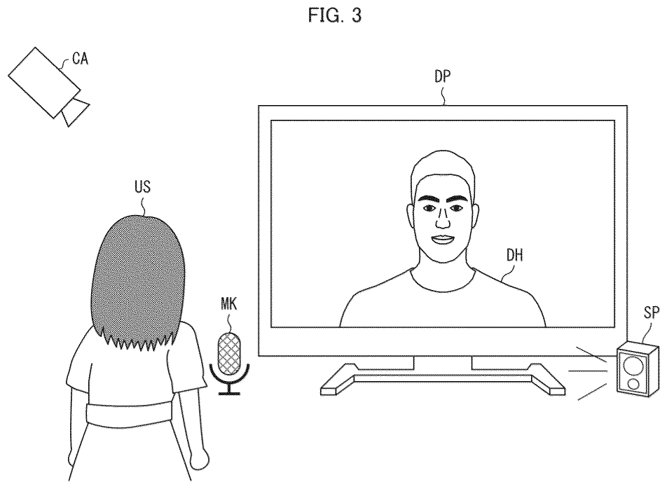

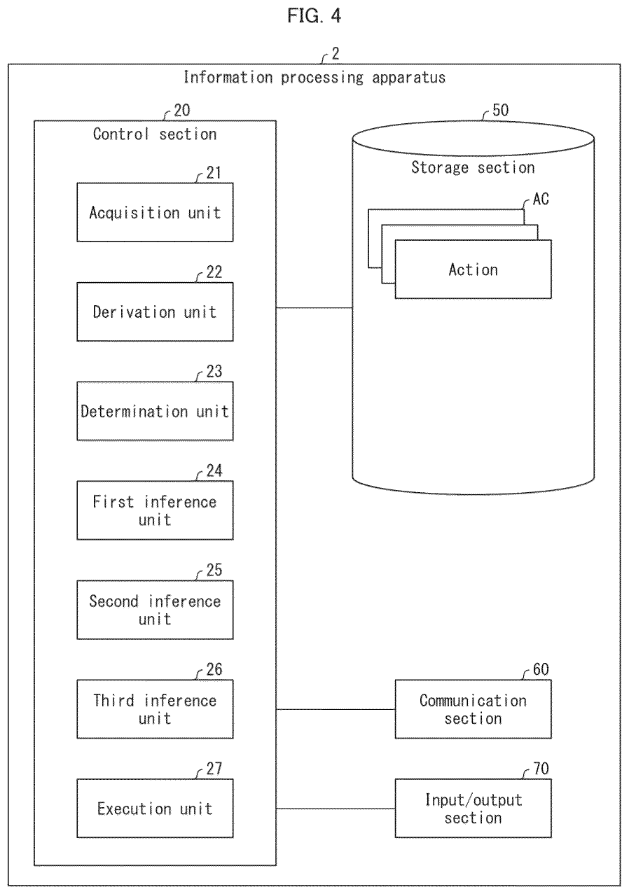

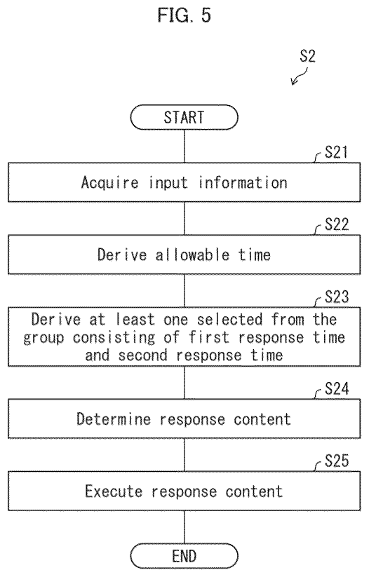

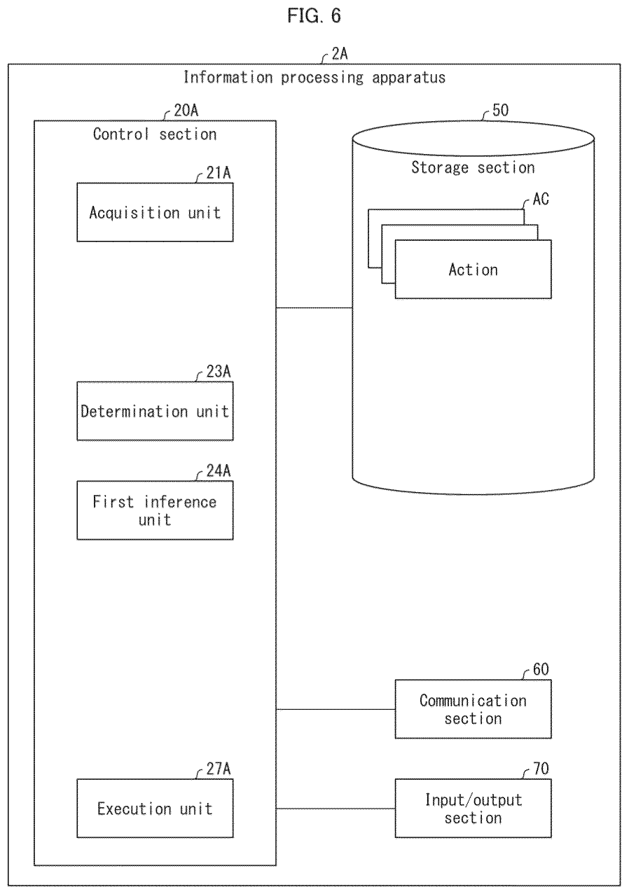

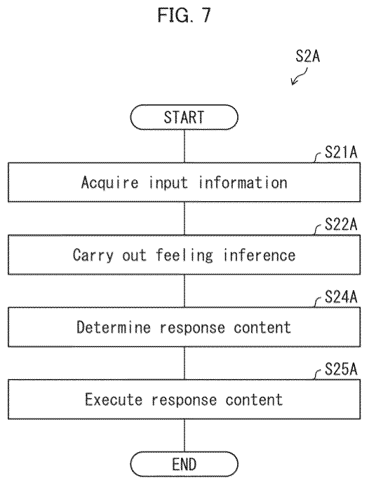

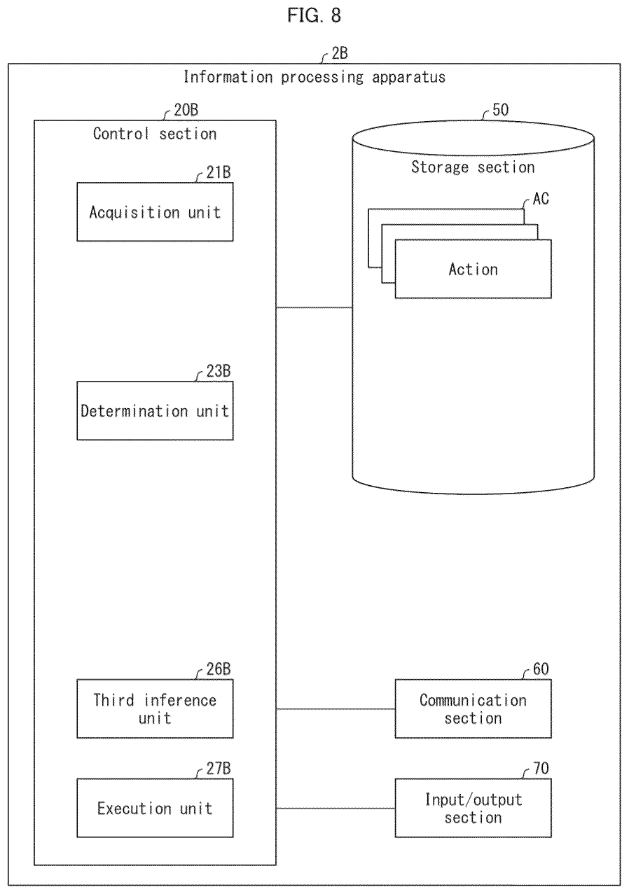

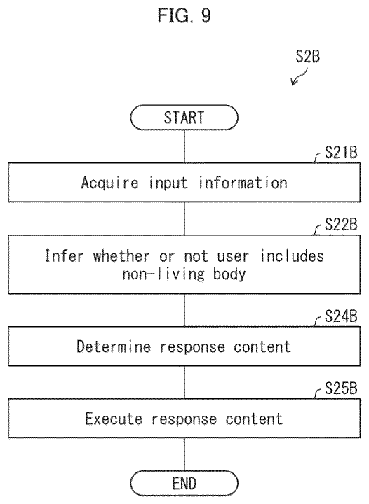

A flow of an information processing method S1 will be described with reference to FIG. 2. FIG. 2 is a flowchart illustrating the flow of the information processing method S1. The information processing method S1 includes an acquisition process S11, a derivation process S12, and a determination process S13, as illustrated in FIG. 2.

(Acquisition process S11)

In the acquisition process S11, the acquisition unit 11 acquires input information. The acquisition unit 11 supplies the acquired input information to the derivation unit 12 and the determination unit 13.

### (Derivation Process S12)

In the derivation process S12, the derivation unit 12 derives at least one selected from the group consisting of a first response time, which is required for a first language model to generate first response information in a case where content indicated by the input information is input into the first language model, and a second response time, which is required for a second language model to generate second response information in a case where the content indicated by the input information is input into the second language model. The derivation unit 12 supplies, to the determination unit 13, the derived at least one selected from the group consisting of the first response time and the second response time.

(Determination process S13)

In the determination process S13, the determination unit 13 determines response content with respect to the input information with reference to the at least one selected from the group consisting of the first response time and the second response time which has been derived by the derivation unit 12.

(Effect of information processing method S1)

As described above, in the information processing method S1, a configuration is employed in which the information processing method S1 includes: the acquisition process S11 for the acquisition unit 11 acquiring input information; the derivation process S12 for the derivation unit 12 deriving at least one selected from the group consisting of a first response time, which is required for a first language model to generate first response information in a case where content indicated by the input information is input into the first language model, and a second response time, which is required for a second language model to generate second response information in a case where the content indicated by the input information is input into the second language model; and the determination process S13 for the determination unit 13 determining response content with respect to the input information with reference to the at least one selected from the group consisting of the first response time and the second response time which has been derived by the derivation unit 12. Thus, according to the information processing method S1, an effect similar to the effect brought about by the above-described information processing apparatus 1 is obtained.

### Second Example Embodiment

A second example embodiment which is an example of an embodiment of the present invention will be described in detail with reference to the drawings. The same reference numerals are given to constituent elements which have functions identical with those described in the above-described example embodiment, and descriptions as to such constituent elements are omitted as appropriate. The scope of the application of the technical means employed in the present example embodiment is not limited to the present example embodiment. That is, each technical means employed in the present example embodiment can also be employed in other example embodiments included in the present disclosure to the extent that no particular technical obstruction occurs. In addition, each technical means illustrated in the drawings which are referred to for the description of the present example embodiment can also be employed in other example embodiments included in the present disclosure to the extent that no particular technical obstruction occurs.

### (Overview of Information Processing Apparatus 2)

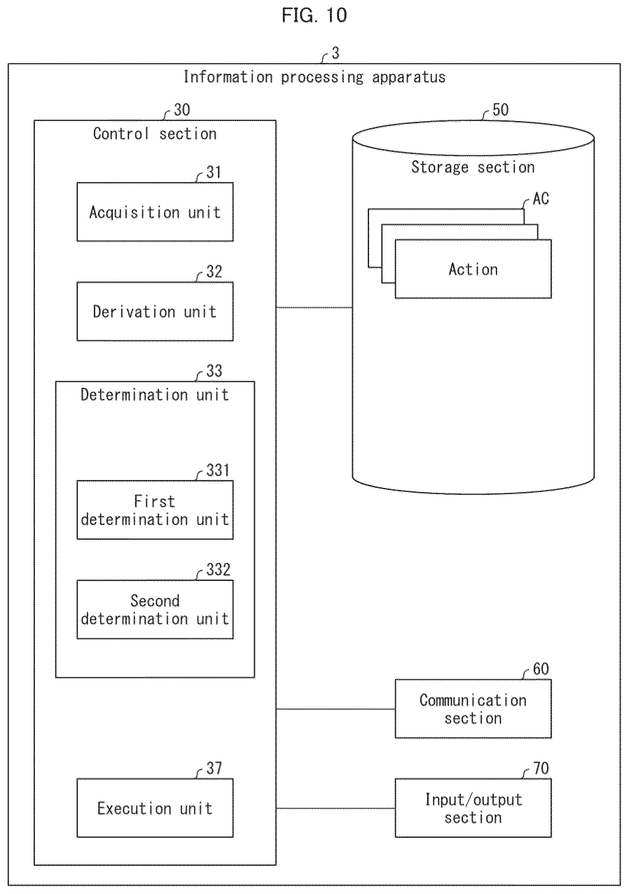

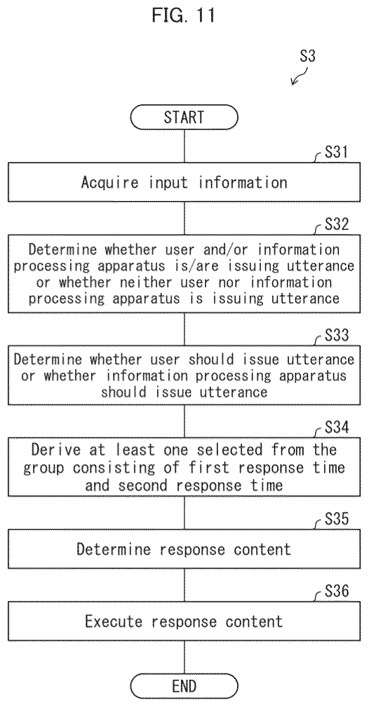

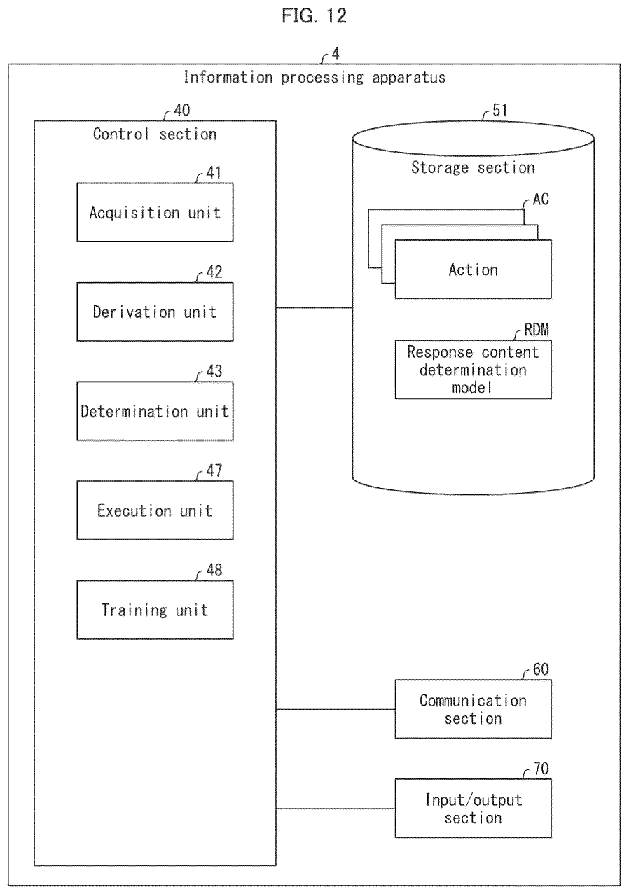

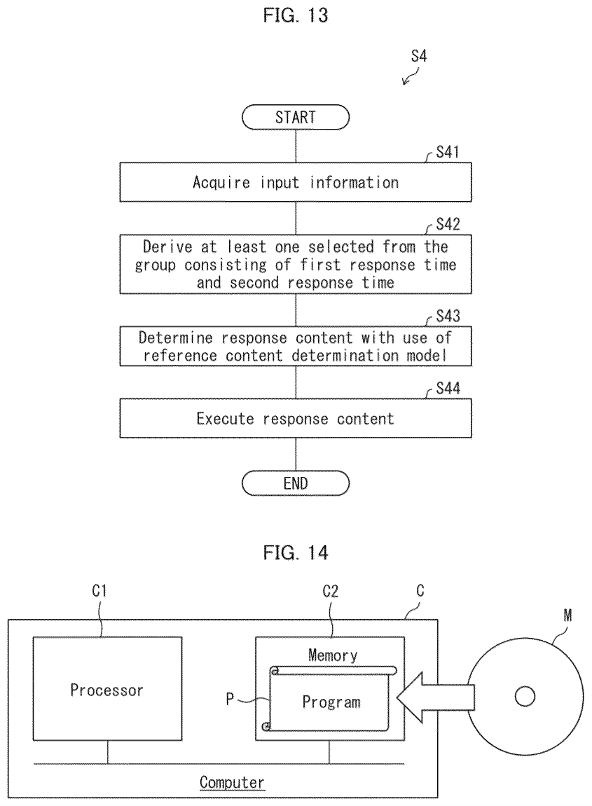

An information processing apparatus 2 is an apparatus that makes a response to input information indicating input from at least one target (user). An overview of an example of a process carried out by the information processing apparatus 2 will be described with reference to FIG. 3. FIG. 3 is a view illustrating an overview of an example of a process carried out by the information processing apparatus 2.

In the example illustrated in FIG. 3, the information processing apparatus 2 acquires, from a user US, an utterance of the user US via at least one selected from the group consisting of a microphone MK and a camera CA. Then, the information processing apparatus 2 outputs, on the basis of the utterance of the user US as input information, response content with respect to the utterance from the speaker SP. That is, the information processing apparatus 2 has a conversation with the user US.

In addition, the information processing apparatus 2 may display a digital human DH on a display DP. In this case, the information processing apparatus 2 may display the digital human DH on the display DP as if the digital human DH is uttering the response content output from the speaker SP. In other words, the information processing apparatus 2 may display the digital human DH on the display DP in such a manner that the user US experiences a feeling that the user US is having a conversation with the digital human DH.

Note that a similar function is also applicable to an apparatus such as a robot. That is, the information processing apparatus 2 can also output response content to a robot and other automatic response apparatus to cause these apparatuses to behave as if the apparatuses are having a conversation with the user US. Such a configuration enables the information processing apparatus 2 to provide more diverse response forms and improve user's experience.

In the present disclosure, the input information is not limited to an utterance. Other examples of the input information include a gesture input via the camera CA, data input via a line-of-sight input apparatus, and data input via a keyboard. In addition, the response from the information processing apparatus 2 is also not limited to an audio response. As an example, the information processing apparatus 2 may display a gesture indicating response content or may display response content in text form. That is, the conversation in the present disclosure includes a spoken conversation, a gesture-based conversation, a textual conversation, and a combination thereof.

In addition, in the present disclosure, the user is not limited to a living body (human, animal) and may be a non-living body. Other examples of the target includes a machine learning model that has been trained to issue an utterance.

### (Configuration of Information Processing Apparatus 2)

A configuration of the information processing apparatus 2 will be described with reference to FIG. 4. FIG. 4 is a block diagram illustrating the configuration of the information processing apparatus 2.

The information processing apparatus 2 includes a control section 20, a storage section 50, a communication section 60, and an input/output section 70, as illustrated in FIG. 4.

The storage section 50 stores data to be referred to by the control section 20. Examples of the storage section 50 include, but not limited to, a flash memory, a hard disk drive (HDD), a solid state drive (SSD), and a combination thereof.

Examples of the data stored in the storage section 50 include data acquired by an acquisition unit 21 and an action AC.

The action AC is a preset action, and includes, as an example, saying a supportive response such as “Ah-ha.” and “I see.” and a gesture such as nodding. In addition, the action AC may be an action generated by a language model LM (for example, a first language model LM1 which will be described later).

The communication section 60 is an interface that transmits and receives data via a network. Examples of the communication section 60 include, but not limited to, a communication chip in various communication standards such as Ethernet (registered trademark), Wi-Fi (registered trademark), and radio communications standard for mobile data communications networks, and a USB-compliant connector.

As an example, the communication section 60 transmits input information to another apparatus in which a language model LM is stored and receives response information from another apparatus in which the language model LM is stored.

The input/output section 70 is an interface that receives input of data and outputs data. Examples of the input/output section 70 include, but not limited to, a microphone, a camera, a line-of-sight input apparatus, a keyboard, a touch pad, a speaker, and a liquid crystal display.

As an example, the input/output section 70 acquires input information input by a user. The input/output section 70 supplies the acquired input information to the control section 20. As another example, the input/output section 70 displays an image indicated by an image signal that has been supplied from the control section 20.

### (Control Section 20)

The control section 20 controls constituent elements included in the information processing apparatus 2. In addition, the control section 20 includes an acquisition unit 21, a derivation unit 22, a determination unit 23, a first inference unit 24, a second inference unit 25, a third inference unit 26, and an execution unit 27, as illustrated in FIG. 4. The acquisition unit 21, the derivation unit 22, the determination unit 23, the first inference unit 24, the second inference unit 25, the third inference unit 26, and the execution unit 27 realize an acquisition means, a derivation means, a determination means, a first inference means, a second inference means, a third inference means, and an execution means, respectively, in the present example embodiment.

The acquisition unit 21 acquires data from the communication section 60 or the input/output section 70. The acquisition unit 21 stores the acquired data in the storage section 50. As an example, the acquisition unit 21 acquires input information. As another example, the acquisition unit 21 acquires first response information and second response information.

The derivation unit 22 derives a response time which is required for each of a plurality of language models LM to generate response information in a case where content indicated by the input information is input into each of the plurality of language models LM. The derivation unit 22 supplies the derived response time to the determination unit 23. As described above, the response time derived by the derivation unit 22 includes at least one selected from the group consisting of a response time in a case where the content indicated by the input information is actually input into a language model LM and a response time in a case where the content indicated by the input information is not actually input into the language model LM, but it is assumed that the content indicated by the input information is input into the language model LM.

The language model LM is a model that has undergone machine learning so as to use, as input, the content indicated by the input information and generate response information indicating response content. Examples of the language model LM include, but not limited to, chatbot, bidirectional encoder representations from transformers (BERT), generative pre-trained transformer (GPT), text-to-text transfer transformer (T5), robustly optimized BERT approach (ROBERTa), efficiently learning an encoder that classifies token replacements accurately (ELECTRA), and a trained model (e.g., chat generative pre-trained transformer (ChatGPT)) generated by carrying out transfer learning or fine tuning with use of a pre-trained model.

Note that the language model LM is not necessarily limited to a model that has undergone machine learning. For example, an example of the language model LM may be, as an example, the one that performs an operation based on a predetermined scenario or based on a rule.

The plurality of language models LM may be stored in another apparatus capable of communicating with the information processing apparatus 2. Alternatively, at least one of the plurality of language models LM may be stored in the storage section 50. The phrase “the language model LM is stored” indicates that a parameter defining the language model LM is stored.

The number of the plurality of language models LM is not limited. The plurality of language models LM only need to be any language models LM that differ from each other in, for example, processing speed, type of information possessed, and response policy. In addition, one language model LM may be configured to also serve as a plurality of language models LM. In the present disclosure, a case where two language models LM (a first language model LM1 and a second language model LM2) are used is described.

The first language model LM1 and the second language model LM2 are not particularly limited. As an example, the first language model LM1 is a model that generates a response at a high speed but generates simple response content. The second language model LM2 is a model that generates a response at a speed lower than the speed at which the first language model LM1 generates the response, but generates response content which is more sophisticated than the response content generated by the first language model LM1.

The derivation unit 22 derives a first response time T(1) which is required for the first language model LM1 to generate first response information in a case where the content indicated by the input information is input into the first language model LM1. In addition, the derivation unit 22 derives a second response time T(2) which is required for the second language model LM2 to generate second response information in a case where the content indicated by the input information is input into the second language model LM2. The derivation unit 22 derives at least one selected from the group consisting of the first response time T(1) and the second response time T(2).

In addition, the response time derived by the derivation unit 22 includes a time from the input of the input information into the language model LM to the acquisition of response information. That is, the response time derived by the derivation unit 22 includes: (1) a time from the output of the input information by the information processing apparatus 2 to the acquisition of the input information by an apparatus in which the language model LM is stored; (2) a time required for the language model LM to generate response information; and (3) a time from the output of the response information by the apparatus in which the language model LM is stored to the acquisition of the response information by the information processing apparatus 2.

In addition, the derivation unit 22 further derives an allowable time T(u) from the acquisition of the input information to the output of the response information with respect to the input information.

The allowable time T(u) is a time that elapses from the completion of input of the input information by the user to the output of the response content by the information processing apparatus 2 and that does not make the user feel that the time is unnaturally long. In other words, the allowable time T(u) is a time that the user can wait without discomfort from the completion of input of the input information by the user to the start of output of the response content by the information processing apparatus 2.

As an example, the derivation unit 22 derives an allowable time T(u) appropriate to input information. For example, in a case where the input information is a greeting, the derivation unit 22 derives an allowable time T(u)=1 second. In addition, in a case where the input information is a closed question, the derivation unit 22 derives an allowable time T(u)=1.5 seconds. In addition, in a case where the input information is open-ended question, the derivation unit 22 derives an allowable time T(u)=2 seconds. In addition, in a case where the input information is a question that requires urgent attention, the derivation unit 22 derives an allowable time T(u)=1 second.

As another example, the derivation unit 22 derives an allowable time T(u) appropriate to a speed at which the user inputs input information. For example, in a case where the user inputs the input information at a speed faster than a predetermined speed (e.g., a case where the user speaks fast or the like case), there is a possibility that the user is in a hurry. Thus, the derivation unit 22 derives an allowable time T(u)=1 second. Further, in a case where the user inputs the input information at a speed slower than the predetermined speed (e.g., a case where the user speaks slowly or the like case), there is a possibility that the user is not in a hurry. Thus, the derivation unit 22 derives an allowable time T(u)=2 seconds.

The determination unit 23 determines response content with respect to the input information. As an example, the determination unit 23 determines response content with respect to the input information with reference to the at least one selected from the group consisting of the first response time T(1) and the second response time T(2) which has been derived by the derivation unit 22. In addition, the determination unit 23 determines response content by inputting content indicated by the input information into the language model LM. The determination unit 23 supplies the determined response content to the execution unit 27.

In addition, the determination unit 23 determines response content with respect to the input information further with reference to an allowable time T(u) which has been derived by the derivation unit 22. In addition, the determination unit 23 determines response content further with reference to an inference result which is a result of inference carried out by at least one selected from the group consisting of the first inference unit 24, the second inference unit 25, and the third inference unit 26. Examples of the process carried out by the determination unit 23 will be described later.

The first inference unit 24 carries out, with reference to the input information acquired from the user, inference of a feeling related to the user. Examples of the feeling include pleasure, confusion, surprise, and other feelings. The first inference unit 24 supplies the inference result to the determination unit 23.

As an example, the first inference unit 24 carries out inference of the feeling of the user with use of a machine learning model that has been trained to use input information as input, infer a feeling related to the user who has inputted the input information, and output information indicating the inferred feeling. The first inference unit 24 may be configured to be included in the determination unit 23 or may be provided separately from the determination unit 23 as illustrated in FIG. 4.

The second inference unit 25 carries out inference of content expected by the user with reference to the input information acquired from the user. Examples of the expected content include an accurate answer, a quick answer, and an expression of empathy that is not an answer. The second inference unit 25 supplies the inference result to the determination unit 23.

As an example, the second inference unit 25 infers the content expected by the user with use of a machine learning model that has been trained to use input information as input, infer content expected by the user who has inputted the input information, and output information indicating the inferred content. The second inference unit 25 may be configured to be included in the determination unit 23 or may be provided separately from the determination unit 23 as illustrated in FIG. 4.

The third inference unit 26 infers, with reference to the input information acquired from the user, whether or not the user includes a non-living body. Examples of the non-living body include a machine learning model that has been trained to issue an utterance. Examples of the machine learning model include a machine learning model (inference model) that has been trained with reference to training data which includes an utterance issued by a user including a non-living body and a label attached to the utterance. The third inference unit 26 supplies the inference result to the determination unit 23.

Here, a configuration may be employed in which the input information includes an utterance issued by a user, and a process carried out by the third inference unit 26 includes a determination process for sequentially determining, with reference to input information sequentially acquired from the user, whether any user is issuing an utterance or no user is issuing an utterance. In other words, in a case where content of an utterance issued by a user (content of utterances issued by a plurality of users) is unnatural or in a case where the length of a pause between utterances issued by the user is unnatural, the third inference unit 26 infers that the user includes a non-living body.

As an example, the third inference unit 26 infers whether or not the user includes a non-living body with use of a machine learning model that has been trained to use input information as input, infer whether or not the user who has inputted the input information includes a non-living body, and output information indicating a result of the inference. The third inference unit 26 may be configured to be included in the determination unit 23 or may be provided separately from the determination unit 23 as illustrated in FIG. 4.

The execution unit 27 executes response content which has been determined by the determination unit 23. As an example, the execution unit 27 outputs the response content to the input/output section 70 so that a sound including the response content is output. As another example, the execution unit 27 outputs the response content to the input/output section 70 so that a digital human DH including the response content (for example, a digital human DH that utters the response content and a digital human DH that performs an action AC which is the response content) is displayed. An example of a process carried out by the execution unit 27 will be described in an example of a process carried out by the determination unit 23 which will be described later.

### Example of Process Carried Out by Determination Unit 23

An example of a process carried out by the determination unit 23 will be described. The following will describe a case where the first response time T(1) is shorter than the second response time T(2).

### Process Example 1

As an example, in a case where the allowable time T(u) derived by the derivation unit 22 is shorter than the first response time T(1), the determination unit 23 includes at least one of a plurality of preset actions AC in the response content. In other words, in a case where the acquisition unit 21 cannot acquire the first response information and the second response information that have been generated by the first language model LM1 and the second language model LM2, respectively, within the allowable time T(u), the determination unit 23 determines the response content with respect to the input information to be response content including a preset action AC.

As an example, the following assumes a case in which the content indicated by the input information is “What is this?”. In this case, in a case where the allowable time T(u) derived by the derivation unit 22 is shorter than the first response time T(1), the determination unit 23 includes, in the response content, an action AC of issuing an utterance of “Well.” among the actions AC stored in the storage section 50. The execution unit 27 executes the response content that has been determined by the determination unit 23 so that “Well.” is output from the speaker within the allowable time T(u).

In this case, the execution of the response content by the execution unit 27 results in the extension of the allowable time T(u). Thus, the derivation unit 22 re-derives the allowable time T(u). A configuration may be employed in which, in a case where the re-derived allowable time T(u) is shorter than the first response time T(1), the determination unit 23 repeatedly includes the action AC in the response content. In this case, the determination unit 23 may be configured to include, in the response content, an action AC that differs from the previously determined action AC. For example, in a case where the previously determined action AC is an action of issuing an utterance of “Well.”, the determination unit 23 includes an action AC of issuing an utterance of see. “, which “Let's differs from the previously determined action AC, in the response content.

As another example, the determination unit 23 includes, in the response content, an action AC of nodding among the actions AC stored in the storage section 50. The execution unit 27 executes the response content that has been determined by the determination unit 23 so that an image in which the digital human DH is nodding is displayed within the allowable time T(u).

With this configuration, the information processing apparatus 2 outputs response content including an action AC within the allowable time T(u) and thus makes it possible to naturally have a conversation with a user without generating any pause that makes the user feel unnatural.

Further, the determination unit 23 may determine response content further with reference to an inference result obtained by the first inference unit 24. In other words, the determination unit 23 may determine the response content in accordance with a feeling related to a user. This configuration may be such that each of the plurality of actions AC stored in the storage section 50 and a feeling related to the user are stored in such a manner as to be associated with each other, and the determination unit 23 selects an action AC which is associated with the inference result obtained by the first inference unit 24.

For example, the following assumes a case in which the content indicated by the input information is “Um, Excuse me.”, and the inference result obtained by the first inference unit 24 indicates that the user feels anxious. In this case, the determination unit 23 includes, in the response content, an action AC of issuing an utterance of “How can I help you?”, which is associated with the inference result that the user feels anxious, among the actions AC stored in the storage section 50. The execution unit 27 executes the response content that has been determined by the determination unit 23 so that “How can I help you?” is output from the speaker within the allowable time T(u).

With this configuration, the information processing apparatus 2 outputs response content appropriate to a feeling of the user within the allowable time T(u) and thus makes it possible to have a conversation in accordance with the feeling of the user.

Further, the determination unit 23 may determine response content further with reference to an inference result obtained by the second inference unit 25. In other words, the determination unit 23 may determine the response content in accordance with content expected by the user. This configuration may be such that each of the plurality of actions AC stored in the storage section 50 and content expected by the user are stored in such a manner as to be associated with each other, and the determination unit 23 selects an action AC which is associated with the inference result obtained by the second inference unit 25.

For example, the following assumes a case in which the content indicated by the input information is “The character XXX is cute, isn't it?”, and the inference result obtained by the second inference unit 25 indicates that the user is expecting to receive empathy. In this case, the determination unit 23 includes, in the response content, an action AC of issuing an utterance of “Yes”, which is associated with the inference result that the user is expecting to receive empathy, among the actions AC stored in the storage section 50. The execution unit 27 executes the response content that has been determined by the determination unit 23 so that “Yes.” is output from the speaker within the allowable time T(u).

With this configuration, the information processing apparatus 2 outputs response content expected by the user within the allowable time T(u) and thus makes it possible to have a conversation that fulfills the expectation of the user.

Further, the determination unit 23 may determine response content further with reference to an inference result obtained by the third inference unit 26. In other words, the determination unit 23 may determine the response content in accordance with whether or not the user includes a non-living body. This configuration may be such that each of the plurality of actions AC stored in the storage section 50 and an inference result indicating that the user includes (or does not include) a non-living body are stored in such a manner as to be associated with each other, and the determination unit 23 selects an action AC which is associated with the inference result obtained by the third inference unit 26.

For example, the following assumes a case in which the content indicated by the input information is “What is this?”, and the inference result obtained by the third inference unit 26 indicates that the user does not include a non-living body. In this case, the determination unit 23 includes, in the response content, an action AC of issuing an utterance of “Well.” and displaying an advertisement, which is associated with the inference result indicating that the user does not include a non-living body, among the actions AC stored in the storage section 50. The execution unit 27 executes the response content that has been determined by the determination unit 23 so that “Well.” is output from the speaker within the allowable time T(u), and an advertisement is displayed on the display apparatus.

On the other hand, the following assumes a case in which the content indicated by the input information is “What is this?”, and the inference result obtained by the third inference unit 26 indicates that the user includes a non-living body. In this case, the determination unit 23 includes, in the response content, an action AC of issuing an utterance of “Well.”, which is associated with the inference result indicating that the user includes a non-living body, among the actions AC stored in the storage section 50. The execution unit 27 executes the response content that has been determined by the determination unit 23 so that “Well.” is output from the speaker within the allowable time T(u).

With this configuration, the information processing apparatus 2 outputs, within the allowable time T(u), response content in accordance with whether or not the user includes a non-living body. Thus, the information processing apparatus 2 does not output an action AC (such as, for example, displaying an advertisement) that is ineffective even if the action AC is output for a non-living body, and thus makes it possible to efficiently carry out a process of having a conversation with the user.

Further, the determination unit 23 may determine response content with reference to at least one selected from the group consisting of an inference result obtained by the first inference unit 24, an inference result obtained by the second inference unit 25, and an inference result obtained by the third inference unit 26.

### Process Example 2

As another example, in a case where the allowable time T(u) derived by the derivation unit 22 is longer than the first response time T(1) and shorter than the second response time T(2), the determination unit 23 includes first response information in the response content. In other words, in a case where the acquisition unit 21 acquires the first response information within the allowable time T(u), the determination unit 23 determines the response content to be response content including first response content.

For example, the following assumes a case in which the content indicated by the input information is “What is this?”. In this case, in a case where the allowable time T(u) derived by the derivation unit 22 is longer than the first response time T(1) and shorter than the second response time T(2), the determination unit 23 includes, in the response content, “Let me check it.” indicated by the first response information. The execution unit 27 executes the response content that has been determined by the determination unit 23 so that “Let me check it.” is output from the speaker within the allowable time T(u).

In the present example as well, the determination unit 23 may determine response content further with reference to at least one selected from the group consisting of an inference result obtained by the first inference unit 24, an inference result obtained by the second inference unit 25, and an inference result obtained by the third inference unit 26.

With this configuration, the information processing apparatus 2 outputs response content including the first response information within the allowable time T(u) and thus makes it possible to output, to the user, response content generated by the first language model M1 without generating any pause that makes the user feel unnatural.

### Process Example 3

As still another example, in a case where the allowable time T(u) derived by the derivation unit 22 is longer than the second response time T(2), the determination unit 23 includes second response information in the response content. In other words, in a case where the acquisition unit 21 acquires the second response information within the allowable time T(u), the determination unit 23 determines the response content to be response content including second response content.

For example, the following assumes a case in which the content indicated by the input information is “What is this?”. In this case, in a case where the allowable time T(u) derived by the derivation unit 22 is longer than the second response time T(2), the determination unit 23 includes, in the response content, “It is XXX. XXX is . . . ” indicated by the second response information. The execution unit 27 executes the response content that has been determined by the determination unit 23 so that “It is XXX. XXX is . . . ” is output from the speaker within the allowable time T(u).

In the present example as well, the determination unit 23 may determine response content further with reference to at least one selected from the group consisting of an inference result obtained by the first inference unit 24, an inference result obtained by the second inference unit 25, and an inference result obtained by the third inference unit 26.

In this configuration, in a case where the determination unit 23 refers to the input information and determines that response information generated by the first language model LM1 is inappropriate, the determination unit 23 may not input the input information into the first language model LM1.

With this configuration, the information processing apparatus 2 outputs response content including the second response information within the allowable time T(u) and thus makes it possible to output, to the user, advanced response content generated by the second language model M2 without generating any pause that makes the user feel unnatural.

### Process Example 4

As yet another example, until second response information obtained by the second language model LM2 is acquired, the determination unit 23 and the execution unit 27 repeat (i) determination of response content including at least one selected from the plurality of actions AC and the first response information and (ii) execution of the response content, respectively.

For example, the following assumes a case in which the content indicated by the input information is “What is this?”. In this case, until the second response information is acquired, the determination unit 23 includes an action AC of issuing an utterance of “Hm.” in the response content, includes an action AC of tilting the head to one side in the response content, and/or includes, in the response content, “Let me check it.” which is indicated by the first response information. Until the second response information is acquired, the execution unit 27 outputs “Hm.” from the speaker, displays an image in which the digital human DH is tilting his/her head to one side, and/or outputs “Let me check it.” from the speaker.

In this case, the execution unit 27 may execute randomly different instances of response content at predetermined time intervals (for example, at an interval of 1 second), execute the same response content at predetermined intervals a predetermined number of times, execute instances of response content in a random manner at random time intervals, or carry out a combination of these ways of the execution.

In the present example as well, the determination unit 23 may determine response content further with reference to at least one selected from the group consisting of an inference result obtained by the first inference unit 24, an inference result obtained by the second inference unit 25, and an inference result obtained by the third inference unit 26.

With this configuration, until advanced response content is output to the user, the information processing apparatus 2 outputs, to the user, response content including at least one selected from the actions AC and the first response information, without generating any pause that makes the user feel unnatural. Therefore, the information processing apparatus 2 makes it possible to keep the user waiting naturally until advanced response content is output to the user.

### Process example 5

As further another example, the determination unit 23 refers to the input information and makes a change to the input information or makes a determination of response content.

For example, the following assumes a case in which the content indicated by the input information is “Is this?”. In this case, as an example, in a case where the determination unit 23 determines that the language model LM cannot generate response information with respect to the input information of “Is this?”, the determination unit 23 includes “What do you mean?” in response content within the allowable time T(u) in order to prompt input of insufficient information. The execution unit 27 executes the response content that has been determined by the determination unit 23 so that “What do you mean?” is output from the speaker within the allowable time T(u).

As another example, the determination unit 23 may change the input information from “Is this?” to “What is this?” and supply, to the derivation unit 22, the changed input information. As an example, the determination unit 23 changes the input information with reference to a history of information input after the determination unit 23 has prompted input of insufficient information. In this case, as described above, the determination unit 23 determines response content with reference to the allowable time T(u) and the at least one selected from the group consisting of the first response time T(1) and the second response time T(2) which has been derived by the derivation unit 22.

In addition, the determination unit 23 may be configured to identify the number of users and acquire input information according to the identified number of users. For example, the determination unit 23 refers to an image output by the camera and identifies the number of users from the image. Then, in a case where the number of users is one, the determination unit 23 refers to input information acquired from one user. On the other hand, in a case where the number of users is two or more, the determination unit 23 may acquire input information from each of the two or more users. For example, after having acquired the input information from one user, the determination unit 23 may cause the execution unit 27 to issue an utterance of “Do you have any other questions?” in order to acquire input information from other user.

With this configuration, in a case where there is insufficiency in the input information, the information processing apparatus 2 prompts input of insufficient information or changes the input information with use of information that the information processing apparatus 2 has already had. Therefore, the information processing apparatus 2 can make an appropriate response to the user without making an inappropriate response to the input information in which there is insufficiency.

(Flow of Process Carried Out by Information Processing Apparatus 2)

A flow of a process carried out by the information processing apparatus 2 will be described with reference to FIG. 5. FIG. 5 is a flowchart illustrating the flow of the process carried out by the information processing apparatus 2.

### (Step S21)

In step S21, the acquisition unit 21 acquires input information. The acquisition unit 21 stores the input information in the storage section 50.

### (Step S22)

In step S22, the derivation unit 22 derives an allowable time T(u). The derivation unit 22 supplies the derived allowable time T(u) to the determination unit 23.

### (Step S23)

In step S23, the derivation unit 22 derives at least one selected from the group consisting of a first response time T(1) and a second response time T(2). The derivation unit 22 supplies, to the determination unit 23, the derived at least one selected from the group consisting of the first response time T(1) and the second response time T(2).

### (Step S24)

In step S24, the determination unit 23 determines response content with respect to the input information with reference to the allowable time T(u) and at least one selected from the group consisting of the first response time T(1) and the second response time T(2). The determination unit 23 supplies the determined response content to the execution unit 27.

As described above, in accordance with the length of the allowable time T(u), the length of the first response time T(1), and the length of the second response time T(2), the determination unit 23 may include at least one of a plurality of preset actions AC in the response content, may include the first response information in the response content, and/or may include the second response information in the response content.

Further, as described above, the determination unit 23 may determine response content further with reference to at least one selected from the group consisting of an inference result obtained by the first inference unit 24, an inference result obtained by the second inference unit 25, and an inference result obtained by the third inference unit 26.

### (Step S25)

In step S25, the execution unit 27 executes response content which has been determined by the determination unit 23.

### (Effect of Information Processing Apparatus 2)

As described above, in the information processing apparatus 2, the derivation unit 22 calculates the allowable time T(u) from the acquisition of the input information to the output of the response information with respect to the input information, and the determination unit 23 determines response content with respect to the input information further with reference to the allowable time T(u).

Thus, the information processing apparatus 2 outputs response content within the allowable time T(u) and thus makes it possible to naturally have a conversation with a user without generating any pause that makes the user feel unnatural.

### (First Variation)

A first variation will be described in detail with reference to the drawings.

### (Configuration of Information Processing Apparatus 2A)

FIG. 6 is a block diagram illustrating a configuration of an information processing apparatus 2A. As illustrated in FIG. 6, the information processing apparatus 2A includes a control section 20A, a storage section 50, a communication section 60, and an input/output section 70. The storage section 50, the communication section 60, and the input/output section 70 are as described above.

### (Control Section 20A)

The control section 20A controls constituent elements included in the information processing apparatus 2A. In addition, the control section 20A includes an acquisition unit 21A, a determination unit 23A, a first inference unit 24A, and an execution unit 27A, as illustrated in FIG. 6. The acquisition unit 21A, the determination unit 23A, the first inference unit 24A, and the execution unit 27A realize an acquisition means, a determination means, a first inference means, and an execution means, respectively, in the present variation.

The acquisition unit 21A acquires input information from at least one target (user). The acquisition unit 21A stores the acquired information in the storage section 50.

The determination unit 23A determines response content with respect to the input information with reference to an inference result obtained by the first inference unit 24A. The determination unit 23A supplies the determined response content to the execution unit 27A. Examples of the process carried out by the determination unit 23A will be described later.

The first inference unit 24A carries out inference of a feeling related to the user with reference to the input information. A method carried out by the first inference unit 24A for carrying out inference of a feeling related to the user is similar to the method carried out by the above-described first inference unit 24. The first inference unit 24A supplies the inference result to the determination unit 23A.

The execution unit 27A executes response content which has been determined by the determination unit 23A.

### Process Example 1 of Process Carried Out by Determination Unit 23A

For example, the following assumes a case in which the content indicated by the input information is “Um, Excuse me.”, and the inference result obtained by the first inference unit 24A indicates that the user feels anxious. In this case, the determination unit 23A refers to the inference result and includes, in the response content, an action AC of issuing an utterance of “How can I help you?”, which is associated with the inference result that the user feels anxious, among the actions AC stored in the storage section 50. The execution unit 27A executes the response content that has been determined by the determination unit 23A so that “How can I help you?” is output from the speaker.

With this configuration, the information processing apparatus 2A outputs response content appropriate to a feeling of the user and thus makes it possible to have a conversation in accordance with the feeling of the user.

### Process Example 2 of Process Carried Out by Determination Unit 23A

As another example, the determination unit 23A inputs the content indicated by the input information into the language model LM, and, in a case where generated response information is appropriate to the inference result, the determination unit 23A includes the response information in the response content.

For example, the following assumes a case in which the content indicated by the input information is “Um, Excuse me.”, and the inference result obtained by the first inference unit 24A indicates that the user feels anxious. In this case, the determination unit 23A inputs the input information into the first language model LM1. In a case where first response information generated by the first language model LM1 is “Yes, I will answer your questions. Please feel free to ask. “, this first response information is suitable as a response to the user who feels anxious. Thus, the determination unit 23A determines that the first response information is appropriate to the inference result and includes the first response information in the response content. The execution unit 27A executes the response content that has been determined by the determination unit 23A so that “Yes, I will answer your questions. Please feel free to ask.” is output from the speaker.

On the other hand, in a case where the first response information generated by the first language model LM1 is “That is not enough. I cannot answer anything.”, this first response information is not suitable as a response to the user who is confused. Thus, the determination unit 23A determines that the first response information is not appropriate to the inference result and does not include the first response information in the response content. In this case, for example, the determination unit 23A includes, in the response content, an action AC of issuing an utterance of “How can I help you?” among the actions AC stored in the storage section 50. The execution unit 27A executes the response content that has been determined by the determination unit 23A so that “How can I help you?” is output from the speaker.

Note that a configuration may be employed in which the determination unit 23A inputs the content indicated by the input information into the second language model LM2 instead of the first language model LM1, and, in a case where generated second response information is appropriate to the inference result, the determination unit 23A includes the second response information in the response content.

Alternatively, the determination unit 23A may input the content indicated by the input information into the second language model LM2, in addition to the first language model LM1. In this case, a configuration may be employed in which a comparison between the first response information and the second response information is made, and more suitable response information is included in the response content, or a configuration may be employed in which the first response information and the second response information are included in the response content.

With this configuration, the information processing apparatus 2A outputs response content that is appropriate to a feeling of the user and that has been generated by the language model LM and thus makes it possible to output response content that suits a feeling of the user and that has been generated by the language model LM.

### Process Example 3 of Process Carried Out by Determination Unit 23A

As still another example, the information processing apparatus 2A may be configured to further include the above-described derivation unit 22. In this case, the determination unit 23A determines the response content with respect to the input information with reference to, in addition to the inference result obtained by the first inference unit 24A, at least one selected from the group consisting of the first response time T(1) and the second response time T(2) which has been derived by the derivation unit 22.

For example, the following assumes a case in which the content indicated by the input information is “How can I get to YYY?”, and the inference result obtained by the first inference unit 24A indicates that the user feels angry. In this case, the determination unit 23A refers to the first response time T(1) which has been derived by the derivation unit 22 and, until the first response time T(1) elapses, includes, in the response content, an action AC of issuing an utterance of “I'm sorry. Please wait for a moment.”, which is associated with the inference result that the user feels angry, among the actions AC stored in the storage section 50. The execution unit 27A executes the response content that has been determined by the determination unit 23A so that “I'm sorry. Please wait for a moment.” is output repeatedly from the speaker until the first response time T(1) elapses.

After the acquisition unit 21A has acquired the first response information, the determination unit 23A determines whether or not the first response information is suitable for the user who feels angry. For example, in a case where the first response information is “To get to YYY, take a train bound for ZZZ . . . “, the first response information is suitable for the user who feels angry. Thus, the determination unit 23A includes the first response information in the response content. The execution unit 27A executes the response content that has been determined by the determination unit 23A so that “To get to YYY, take a train bound for ZZZ . . . ” is output from the speaker. On the other hand, in a case where the first response information is “I don't know.”, the first response information is not suitable for the user who feels angry. Thus, until the second response time T(2) elapses, the determination unit 23A includes, in the response content, an action AC of issuing an utterance of “I'm sorry. Please wait for a few more moments.”, which is associated with the inference result that the user feels angry, among the actions AC stored in the storage section 50. The execution unit 27A executes the response content that has been determined by the determination unit 23A so that “I'm sorry. Please wait for a few more moments.” is output repeatedly from the speaker until the second response time T(2) elapses.

After the second response time T(2) has elapsed, and the acquisition unit 21A has acquired the second response information, the determination unit 23A includes the second response information in the response content. In this case, as in the case of the first response information, in a case where the second response information is suitable for the user who feels angry, the determination unit 23A includes the second response information in the response content. On the other hand, in a case where the second response information is not suitable for the user who feels angry, the determination unit 23A includes, in the response content, an action AC of issuing an utterance of “I'm sorry. Please ask a station staff.”, which is associated with the inference result that the user feels angry, among the actions AC stored in the storage section 50.

With this configuration, the information processing apparatus 2A makes it possible to naturally have a conversation with the user without generating a pause that makes the user feel unnatural until response content that is appropriate to a feeling of the user and that has been generated by the language model LM is output.

### Process example 4 of process carried out by determination unit 23A

As still another example, the information processing apparatus 2A may be configured to further include the above-described second inference unit 25. In this case, the determination unit 23A determines response content with respect to the input information with reference to, in addition to the inference result obtained by the first inference unit 24A (hereinafter referred to as “first inference result”), an inference result obtained by the second inference unit 25 (hereinafter referred to as “second inference result”).

This configuration may be such that each of the plurality of actions AC stored in the storage section 50, the first inference result, and the second inference result are stored in such a manner as to be associated with each other, and the determination unit 23A selects an action AC which is associated with the first inference result obtained by the second inference unit 24A and the second inference result obtained by the second inference unit 25.

For example, the following assumes a case in which the content indicated by the input information is “I had a bad thing happened to me . . . “, the first inference result indicates that the user feels sad, and the second inference result indicates that the user is expecting to receive empathy. In this case, the determination unit 23A first selects at least one action AC which is associated with the first inference result that the user feels sad among the actions AC stored in the storage section 50.

For example, in a case where a plurality of actions AC selected is an action of issuing an utterance of “Don't let it bother you.” and an action of issuing an utterance of “It was tough.”, the determination unit 23A includes, in the response content, the action AC of issuing an utterance of “It was tough.”, which is associated with the second inference result that the user is expecting to receive empathy, among the selected actions AC. The execution unit 27A executes the response content that has been determined by the determination unit 23A so that “It was tough.” is output from the speaker.

With this configuration, the information processing apparatus 2A makes it possible to output response content that is appropriate to a feeling of the user and that is expected by the user.

### (Flow of Process Carried Out by Information Processing Apparatus 2A)

A flow of a process carried out by the information processing apparatus 2A will be described with reference to FIG. 7. FIG. 7 is a flowchart illustrating the flow of the process carried out by the information processing apparatus 2A.

### (Step S21A)

In step S21A, the acquisition unit 21A acquires input information. The acquisition unit 21A stores the input information in the storage section 50.

### (Step S22A)

In step S22A, the first inference unit 24A carries out inference of a feeling related to the user with reference to the input information. The first inference unit 24A supplies the inference result to the determination unit 23A.

### (Step S24A)

In step S24A, the determination unit 23A determines response content with respect to the input information with reference to the inference result obtained by the first inference unit 24A. The determination unit 23A supplies the determined response content to the execution unit 27A.

As described above, the determination unit 23A may include response information generated by the language model LM in the response content, may determine response content with respect to the input information with reference to at least one selected from the group consisting of the first response time T(1) and the second response time T(2), or may determine response content with respect to the input information with reference to an inference result obtained by the second inference unit 25.

### (Step S25A)

In step S25A, the execution unit 27A executes the response content which has been determined by the determination unit 23A.

### (Effect of Information Processing Apparatus 2A)

As described above, in the information processing apparatus 2A, the determination unit 23A determines response content with respect to input information with reference to an inference result of feeling inference carried out by the first inference unit 24A. Thus, the information processing apparatus 2A makes it possible to have a conversation in accordance with a feeling of a user.

### (Second Variation)

A second variation will be described in detail with reference to the drawings.

### (Configuration of Information Processing Apparatus 2B)

FIG. 8 is a block diagram illustrating a configuration of an information processing apparatus 2B. As illustrated in FIG. 8, the information processing apparatus 2B includes a control section 20B, a storage section 50, a communication section 60, and an input/output section 70. The storage section 50, the communication section 60, and the input/output section 70 are as described above.

### (Control Section 20B)

The control section 20B controls constituent elements included in the information processing apparatus 2B. In addition, the control section 20B includes an acquisition unit 21B, a determination unit 23B, a third inference unit 26B, and an execution unit 27B, as illustrated in FIG. 8. The acquisition unit 21B, the determination unit 23B, the third inference unit 26B, and the execution unit 27B realize an acquisition means, a determination means, a third inference means, and an execution means, respectively, in the present variation.

The acquisition unit 21B acquires input information from at least one target (user). The acquisition unit 21B stores the acquired information in the storage section 50.

The determination unit 23B determines response content with respect to the input information with reference to an inference result obtained by the third inference unit 26B. The determination unit 23B the determined supplies response content to the execution unit 27B. Examples of the process carried out by the determination unit 23B will be described later.

The third inference unit 26B infers whether or not the user includes a non-living body with reference to the input information. A method carried out by the third inference unit 26B for inferring whether or not the user includes a non-living body is similar to the method carried out by the above-described third inference unit 26. The third inference unit 26B supplies an inference result to the determination unit 23B.

The execution unit 27B executes response content which has been determined by the determination unit 23B.

### Example of Process Carried Out by Determination Unit 23B

For example, the following assumes a case in which the content indicated by the input information is “Excuse me.” and “What is this?” which have been uttered simultaneously, and the inference result obtained by the third inference unit 26B indicates that the user includes a non-living body since a pause between the utterance of “Excuse me.” and the utterance of “What is this?” is unnatural.

In this case, the determination unit 23B includes, in the response content, an action AC of issuing an utterance of “Well.”, which is associated with the inference result indicating that the user includes a non-living body, among the actions AC stored in the storage section 50. The execution unit 27B executes the response content that has been determined by the determination unit 23B so that “Well.” is output from the speaker within the allowable time T(u).

On the other hand, the following assumes a case in which the content indicated by the input information is “Excuse me. What is this?”, and the inference result obtained by the third inference unit 26B indicates that the user does not include a non-living body since a pause between the utterance “Excuse me.” and the utterance “What is this?” is natural.

In this case, the determination unit 23B includes, in the response content, an action AC of issuing an utterance of “Well.” and displaying an advertisement, which is associated with the inference result indicating that the user does not include a non-living body, among the actions AC stored in the storage section 50. The execution unit 27B executes the response content that has been determined by the determination unit 23B so that “Well.” is output from the speaker, and an advertisement is displayed on the display apparatus.

As another example, a configuration may be employed in which, in a case where the inference result obtained by the third inference unit 26B indicates that the user does not include a non-living body, the determination unit 23B may be configured to include, in the response content, an action AC of issuing an utterance corresponding response information generated by the language model LM and displaying an advertisement.

With this configuration, the information processing apparatus 2B outputs response content in accordance with whether or not the user includes a non-living body. Thus, the information processing apparatus 2B does not output an action AC (such as, for example, displaying an advertisement) that is ineffective even if the action AC is output for a non-living body, and thus makes it possible to efficiently carry out a process of having a conversation with the user.

### (Flow of Process Carried Out by Information Processing Apparatus 2B)

A flow of a process carried out by the information processing apparatus 2B will be described with reference to FIG. 9. FIG. 9 is a flowchart illustrating the flow of the process carried out by the information processing apparatus 2B.

### (Step S21B)

In step S21B, the acquisition unit 21B acquires input information. The acquisition unit 21B stores the input information in the storage section 50.

### (Step S22B)

In step S22B, the third inference unit 26B infers whether or not the user includes a non-living body with reference to the input information. The third inference unit 26B supplies an inference result to the determination unit 23B.

### (Step S24B)

In step S24B, the determination unit 23B determines response content with respect to the input information with reference to the inference result obtained by the third inference unit 26B. The determination unit 23B supplies the determined response content to the execution unit 27B.

### (Step S25B)

In step S25B, the execution unit 27B executes the response content which has been determined by the determination unit 23B.

### (Effect of Information Processing Apparatus 2B)

As described above, in the information processing apparatus 2B, the determination unit 23B determines response content with respect to input information with reference to an inference result, obtained by the third inference unit 26B, indicating whether or not the user includes a non-living body. Therefore, the information processing apparatus 2B makes it possible to output suitable response content in accordance with each of the following cases: a case where the user does not include a non-living body; and a case where the user includes a non-living body.

### Third Example Embodiment

A third example embodiment which is an example of an embodiment of the present invention will be described in detail with reference to the drawings. The same reference numerals are given to constituent elements which have functions identical with those described in the above-described example embodiment, and descriptions as to such constituent elements are omitted as appropriate. The scope of the application of the technical means employed in the present example embodiment is not limited to the present example embodiment. That is, each technical means employed in the present example embodiment can also be employed in other example embodiments included in the present disclosure to the extent that no particular technical obstruction occurs. In addition, each technical means illustrated in the drawings which are referred to for the description of the present example embodiment can also be employed in other example embodiments included in the present disclosure to the extent that no particular technical obstruction occurs.

### (Configuration of Information Processing Apparatus 3)

A configuration of an information processing apparatus 3 will be described with reference to FIG. 10. FIG. 10 is a block diagram illustrating the configuration of the information processing apparatus 3. As illustrated in FIG. 10, the information processing apparatus 3 includes a control section 30, a storage section 50, a communication section 60, and an input/output section 70. The storage section 50, the communication section 60, and the input/output section 70 are as described above.

### (Control Section 30)

The control section 30 controls constituent elements included in the information processing apparatus 3. In addition, the control section 30 includes an acquisition unit 31, a derivation unit 32, a determination unit 33, and an execution unit 37, as illustrated in FIG. 10. The acquisition unit 31, the derivation unit 32, the determination unit 33, and the execution unit 37 realize an acquisition means, a derivation means, a determination means, and an execution means, respectively, in the present example embodiment.

The acquisition unit 31, like the above-described acquisition unit 21, acquires data from the communication section 60 or the input/output section 70. The acquisition unit 31 stores the acquired data in the storage section 50.

The derivation unit 32, like the above-described derivation unit 22, derives at least one selected from the group consisting of the first response time T(1) and the second response time T(2). The language model LM and a method for the derivation unit 32 deriving the first response time T(1) and the second response time T(2) are as described above.

The determination unit 33, like the above-described determination unit 23, determines response content with respect to the input information with reference to at least one selected from the group consisting of the first response time T(1) and the second response time T(2). In addition, the determination unit 33 determines response content including an utterance.

Further, the determination unit 33 includes a first determination unit 331 and a second determination unit 332, as illustrated in FIG. 10. The first determination unit 331 and the second determination unit 332 realize a first determination means and a second determination means, respectively, in the present example embodiment.

The first determination unit 331 sequentially determines, with reference to input information sequentially acquired from a user, whether the user and/or the information processing apparatus 3 is/are issuing an utterance or whether neither the user nor the information processing apparatus 3 is issuing an utterance. The determination unit 33 determines response content with reference to a determination result (hereinafter referred to as “first determination result”) obtained by the first determination unit 331. An example of a process for the determination unit 33 determining response content with reference to the first determination result will be described later.

The second determination unit 332 sequentially determines, with reference to the input information sequentially acquired from the user, whether the user should issue an utterance or whether the information processing apparatus 3 should issue an utterance. The determination unit 33 determines response content further with reference to a determination result (hereinafter referred to as “second determination result”) obtained by the second determination unit 332.

As an example, the second determination unit 332 sequentially determines, with reference to the first determination result, whether the user should issue an utterance or the information processing apparatus 3 should issue an utterance. An example of a process for the determination unit 33 determining response content with reference to the second determination result will be described later.

The execution unit 37, like the above-described execution unit 27, executes response content which has been determined by the determination unit 33.

### Example 1 of Process for Determination Unit 33 Determining Response Content with Reference to First Determination Result

As an example, the following assumes a case in which the information processing apparatus 3 is not outputting response content, and the user is issuing an utterance. In this case, the first determination unit 331 refers to the input information and determines that the user is issuing an utterance. The determination unit 33 refers to the first determination result obtained by the first determination unit 331 and determines not to output response content since the user is issuing an utterance.

In addition, the following assumes a case in which the user has started issuing an utterance in a period in which the information processing apparatus 3 is outputting response content. In this case, in the period in which the information processing apparatus 3 is outputting the response content, the first determination unit 331 determines that the information processing apparatus 3 is issuing an utterance, and, after the user has started issuing an utterance, the first determination unit 331 determines that the information processing apparatus 3 and the user are issuing utterances. Thus, the determination unit 33 determines not to output response content after the first determination unit 331 has determined that the information processing apparatus 3 and the user are issuing utterances.

In this way, in a case where the first determination result is a result that the user is issuing an utterance, the determination unit 33 acquires input information and does not output response content. Thus, the information processing apparatus 3 makes it possible to appropriately acquire input information from the user.

### Example 2 of Process for Determination Unit 33 Determining Response Content with Reference to First Determination Result

As another example, the following assumes a case in which the information processing apparatus 3 is not outputting response content, and the user is not issuing an utterance. In this case, the first determination unit 331 determines that the information processing apparatus 3 is not issuing an utterance, and the first determination unit 331 refers to input information and determines that the user is not issuing an utterance. Then, the determination unit 33 refers to the first determination result obtained by the first determination unit 331 and determines to output the response content since the user is not issuing an utterance.

In addition, the following assumes a case in which, in a state in which the information processing apparatus 3 has not acquired input information for making a response, the information processing apparatus 3 is not outputting response content, and the user is not issuing an utterance. In this case, the first determination unit 331 determines that neither the information processing apparatus 3 nor the user is issuing an utterance. Then, the determination unit 33 outputs response content that prompts the user to issue an utterance. As an example, the determination unit 33 includes, in the response content, issuing an utterance of “What do you think?”.

In this way, in a case where the first determination result is a result that the user is not issuing an utterance, the determination unit 33 outputs response content or outputs response content prompting the user to issue an utterance. Thus, the information processing apparatus 3 makes it possible to naturally have a conversation with a user without generating any pause that makes the user feel unnatural.

### Example 1 of Process for Determination Unit 33 Determining Response Content with Reference to Second Determination Result

As an example, the following assumes a case in which the information processing apparatus 3 is not outputting response content, and the user is issuing an utterance. In this case, the first determination unit 331 refers to the input information and determines that the user is issuing an utterance. In addition, the second determination unit 332 determines that the user should issue an utterance. Then, the determination unit 33 refers to the first determination result and the second determination result and determines not to output response content since the user is issuing an utterance.

In this case, in a case where a period in which the user is issuing an utterance is equal to or longer than a predetermined period, the second determination unit 332 may determine that the information processing apparatus 3 should issue an utterance. That is, in a case where the user's utterance has continued for a period that is equal to or longer than the predetermined period, the information processing apparatus 3 interrupt and start may outputting response content.

Here, it is preferable that the response content output by the information processing apparatus 3 be response content that has been determined by the determination unit 33 with reference to the input information. For example, the determination unit 33 may include, in the response content, response information (first response information) that has been generated by the language model LM (first language model LM1). This configuration applies to the following cases.

In addition, the following assumes a case in which the user has started issuing an utterance in the middle of a period in which the information processing apparatus 3 is outputting response content. In this case, in the period in which the information processing apparatus 3 is outputting the response content, the first determination unit 331 determines that the information processing apparatus 3 is issuing an utterance, and, after the user has started issuing an utterance, the first determination unit 331 determines that the information processing apparatus 3 and the user are issuing utterances.

In this case, in a case where the period in which the user is issuing an utterance is shorter than the predetermined period, the second determination unit 332 determines that the user's utterance is a supportive response and determines that the information processing apparatus 3 should issue an utterance. Then, the determination unit 33 refers to the first determination result and the second determination result, and continues to output the response content since the user's utterance is a supportive response although the user is issuing the utterance.

On the other hand, in a case where the period in which the user is issuing an utterance is equal to or longer than the predetermined period, the second determination unit 332 determines that the user wants to make another question or is about to add or change information on a question, and the second determination unit 332 determines that the user should issue an utterance. Then, the determination unit 33 refers to the first determination result and the second determination result and determines not to output response content in order to acquire input information from the user.

Thus, even in a case where the first determination result is a result that the user is issuing an utterance, the determination unit 33 determines whether to output response content in accordance with whether the second determination result is a result that the user should issue an utterance or a result that the information processing apparatus 3 should issue an utterance. Therefore, the information processing apparatus 3 does not output response content in a case where the user should issue an utterance, but can output response content in a case where the information processing apparatus 3 should issue an utterance, and thus makes it possible to naturally have a conversation with the user.

### Example 2 of Process for Determination Unit 33 Determining Response Content with Reference to Second Determination Result

As another example, the following assumes a case in which the information processing apparatus 3 is not outputting response content, and the user is not issuing an utterance. In this case, the first determination unit 331 refers to input information and determines that the user is not issuing an utterance. In addition, the second determination unit 332 determines that the information processing apparatus 3 should issue an utterance. Then, the determination unit 33 refers to the first determination result and the second determination result and determines to output response content since the user is not issuing an utterance.

As another example, the following assumes a case in which, from a state in which the user was issuing the utterance, the user finished issuing the utterance and then issued no utterance for a period which is shorter than a predetermined period, and, after that, the user starts issuing the utterance again. That is, the following assumes a case in which the user resumes the utterance immediately after the user has finished issuing the utterance. In this case, the second determination unit 332 determines that the user's utterance has not yet been finished and determines that the user should issue an utterance. Then, the determination unit 33 refers to the first determination result and the second determination result and determines not to output response content since the user continues to issue the utterance.

On the other hand, the following assumes a case in which, from a state in which the user was issuing an utterance, the user finished issuing the utterance, and after that, the user issues no utterance for a period which is equal to or longer than the predetermined period. That is, the following assumes a case in which a predetermined period elapses after the user has finished issuing the utterance. In this case, the second determination unit 332 determines that the information processing apparatus 3 should issue an utterance. Then, the determination unit 33 refers to the first determination result and the second determination result and includes, in response content, issuing an utterance of “I see.” as a supportive response to prevent generation of an unnatural pause. Alternatively, the determination unit 33 may include, in the response content, issuing an utterance of “What do you think?” to be conductive to conversation.

As still another example, in a case where the information processing apparatus 3 continues to output response content, and the user issues no utterance for a period which is equal to or longer than the predetermined period, the second determination unit 332 determines that the information processing apparatus 3 should output the response content in an ongoing manner. Then, the determination unit 33 refers to the first determination result and the second determination result and includes, in response content, issuing an utterance of “Do you have any questions so far?” to insert an interval.

Thus, even e where the first determination result is a result that the user is not issuing an utterance, the determination unit 33 determines whether to output response content in accordance with whether the second determination result is a result that the user should issue an utterance or a result that the information processing apparatus 3 should issue an utterance. Therefore, the information processing apparatus 3 does not output response content in a case where the user should issue an utterance, but can output response content in a case where the information processing apparatus 3 should issue an utterance, and thus makes it possible to naturally have a conversation with the user.

### (Flow of Process Carried Out by Information Processing Apparatus 3)

A flow of a process carried out by the information processing apparatus 3 will be described with reference to FIG. 11. FIG. 11 is a flowchart illustrating the flow of the process carried out by the information processing apparatus 3.

### (Step S31)

In step S31, the acquisition unit 31 acquires input information. The acquisition unit 31 stores the acquired input information in the storage section 50.

### (Step S32)

In step S32, the first determination unit 331 sequentially determines, with reference to input information sequentially acquired from a user, whether the user and/or the information processing apparatus 3 is/are issuing an utterance or whether neither the user nor the information processing apparatus 3 is issuing an utterance. The first determination unit 331 supplies the first determination result to the determination unit 33.

### (Step S33)

In step S33, the second determination unit 332 sequentially determines, with reference to the input information sequentially acquired from the user, whether the user should issue an utterance or whether the information processing apparatus 3 should issue an utterance. The second determination unit 332 supplies the second determination result to the determination unit 33.

### (Step S34)

In step S34, the derivation unit 32 derives at least one selected from the group consisting of a first response time T(1) and a second response time T(2). The derivation unit 32 supplies, to the determination unit 33, the derived at least one selected from the group consisting of the first response time T(1) and the second response time T(2).

### (Step S35)

In step S35, the determination unit 33 determines response content with respect to the input information with reference to at least one selected from the group consisting of the first response time T(1) and the second response time T(2) and the first determination result (or the first determination result and the second determination result). The determination unit 33 supplies the determined response content to the execution unit 37.

### (Step S36)

In step S36, the execution unit 37 executes the response content which has been determined by the determination unit 33.

### (Effect of Information Processing Apparatus 3)

As described above, in the information processing apparatus 3, a determination on whether to output response content is made with reference to the first determination result (or the first determination result and the second determination result). Therefore, the information processing apparatus 3 does not output response content in a case where the user should issue an utterance, but can output response content in a case where the information processing apparatus 3 should issue an utterance, and thus makes it possible to naturally have a conversation with the user.

### Fourth Example Embodiment

A fourth example embodiment which is an example of an embodiment of the present invention will be described in detail with reference to the drawings. The same reference numerals are given to constituent elements which have functions identical with those described in the above-described example embodiment, and descriptions as to such constituent elements are omitted as appropriate. The scope of the application of the technical means employed in the present example embodiment is not limited to the present example embodiment. That is, each technical means employed in the present example embodiment can also be employed in other example embodiments included in the present disclosure to the extent that no particular technical obstruction occurs. In addition, each technical means illustrated in the drawings which are referred to for the description of the present example embodiment can also be employed in other example embodiments included in the present disclosure to the extent that no particular technical obstruction occurs.

### (Configuration of Information Processing Apparatus 4)

A configuration of an information processing apparatus 4 will be described with reference to FIG. 12. FIG. 12 is a block diagram illustrating the configuration of the information processing apparatus 4. As illustrated in FIG. 12, the information processing apparatus 4 includes a control section 40, a storage section 51, a communication section 60, and an input/output section 70. The communication section 60 and the input/output section 70 are as described above.

The storage section 51, like the above-described storage section 50, stores data to be referred to by the control section 40. In addition, the storage section 51 stores a response content determination model RDM.

The response content determination model RDM is a model that has been trained with reference to training data which includes a plurality of sets each including an utterance issued by at least one target (user) and a response to the utterance. As an example, the response content determination model RDM is trained with reference to training data that includes a plurality of sets each including an utterance issued by a user and a plurality of actions AC (such as, for example, a response for filling a gap (such as, for example, issuing an utterance corresponding to a supportive response and nodding) with respect to the utterance and a response for encouraging a user to have a conversation (such as issuing an utterance of “Anything else?”)).

In addition, the response content determination model RDM may include the above-described first language model LM1. With this configuration, the information processing apparatus 4 makes it possible to acquire the first response information with use of the response content determination model RDM.

In addition, a training unit 48 which will be described later may train the response content determination model RDM so that the response content determination model RDM outputs selection information pertaining to whether to output a plurality of actions AC or the first response information obtained by the first language model LM1.

### (Control Section 40)

The control section 40 controls constituent elements included in the information processing apparatus 4. In addition, the control section 40 includes an acquisition unit 41, a derivation unit 42, a determination unit 43, an execution unit 47, and the training unit 48, as illustrated in FIG. 12. The acquisition unit 41, the derivation unit 42, the determination unit 43, the execution unit 47, and the training unit 48 realize an acquisition means, a derivation means, a determination means, an execution means, and a training means, respectively, in the present example embodiment.

The acquisition unit 41, like the above-described acquisition unit 21, acquires data from the communication section 60 or the input/output section 70. The acquisition unit 41 stores the acquired data in the storage section 51.

The derivation unit 42, like the above-described derivation unit 22, derives at least one selected from the group consisting of the first response time T(1) and the second response time T(2). The language model LM and a method for the derivation unit 42 deriving the response times are as described above.

The determination unit 43, like the above-described determination unit 23, determines response content with respect to the input information with reference to at least one selected from the group consisting of the first response time T(1) and the second response time T(2).

In addition, the determination unit 43 determines response content with use of the response content determination model RDM. In this case, the determination unit 43 inputs the input information into the response content determination model RDM and includes, in the response content, response information generated by the response content determination model RDM.

As an example, the determination unit 43 determines the response content with use of the response content determination model RDM until the first response time T(1) elapses. That is, the determination unit 43 includes, in the response content, response information generated by the response content determination model RDM until the determination unit 43 acquires first response information generated by the first language model LM1.

As another example, the determination unit 43 determines the response content with use of the response content determination model RDM until the second response time T(2) elapses. That is, the determination unit 43 includes, in the response content, response information generated by the response content determination model RDM until the determination unit 43 acquires second response information generated by the second language model LM2.

As still another example, in a case where the derivation unit 42 has derived the allowable time T(u), the determination unit 43 determines response content within the allowable time T(u) with use of the response content determination model RDM.

As yet another example, in a case where the training unit 48 which will be described later has trained the response content determination model RDM so that the response content determination model RDM outputs selection information pertaining to whether to output a plurality of actions AC or the first response information obtained by the first language model LM1, the determination unit 43 determines response content with reference to the selection information.

Specifically, in a case where the selection information indicates that the plurality of actions AC is to be output, the determination unit 43 determines response content including at least one of the plurality of actions AC. On the other hand, in a case where the selection information indicates that the first response information obtained by the first language model LM1 is to be output, the determination unit 43 determines response content including the first response information.

The execution unit 47, like the above-described execution unit 27, executes the response content which has been determined by the determination unit 43.

The training unit 48 trains the response content determination model RDM with reference to the training data. With this configuration, the information processing apparatus 4 makes it possible to train the response content determination model RDM so that the response content determination model RDM generates suitable response information.

### (Flow of Process Carried Out by Information Processing Apparatus 4)

A flow of a process carried out by the information processing apparatus 4 will be described with reference to FIG. 13. FIG. 13 is a flowchart illustrating the flow of the process carried out by the information processing apparatus 4.

### (Step S41)

In step S41, the acquisition unit 41 acquires input information. The acquisition unit 41 stores the acquired input information in the storage section 51.

### (Step S42)

In step S42, the derivation unit 42 derives at least one selected from the group consisting of a first response time T(1) and a second response time T(2). The derivation unit 42 supplies, to the determination unit 43, the derived at least one selected from the group consisting of the first response time T(1) and the second response time T(2).

### (Step S43)

In step S43, the determination unit 43 determines response content with use of a response content determination model RDM. The determination unit 43 supplies the determined response content to the execution unit 47.

As described above, the determination unit 43 may determine the response content with use of the response content determination model RDM until the first response time T(1) elapses. Further, the determination unit 43 may determine the response content with use of the response content determination model RDM until the second response time T(2) elapses. Further, in a case where the derivation unit 42 has derived the allowable time T(u), the determination unit 43 may determine the response content within the allowable time T(u) with use of the response content determination model RDM.

### (Step S44)

In step S44, the execution unit 47 executes the response content which has been determined by the determination unit 43.

### (Effect of Information Processing Apparatus 4)

As described above, in the information processing apparatus 4, the determination unit 43 determines response content with use of the response content determination model RDM that has been trained with reference to the training data which includes a plurality of sets each including an utterance issued by a user and a response to the utterance. Therefore, the information processing apparatus 4 determines, with use of the response content determination model RDM, response content in response to the utterance of the user, and thus makes it possible to naturally have a conversation with the user.

### Software Implementation Example

Some or all of functions of the information processing apparatuses 1, 2, 2A, 2B, 3, and 4 (hereinafter also referred to as “the above-described apparatuses”) can be realized by hardware such as an integrated circuit (IC chip) or can be alternatively realized by software.

In the latter case, the above-described apparatuses are each realized by, for example, a computer that executes instructions of a program that is software realizing the foregoing functions. FIG. 14 illustrates an example of such a computer (hereinafter referred to as “computer C”). FIG. 14 is a block diagram illustrating a hardware configuration of the computer C that functions as the above-described apparatuses.

The computer C includes at least one processor C1 and at least one memory C2. The at least one memory C2 stores a program P for causing the computer C to operate as the above-described apparatuses. In the computer C, the processor C1 reads the program P from the memory C2 and executes the program P, so that the functions of the above-described apparatuses are realized.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these. As the memory C2, for example, it is possible to use a flash memory, a hard disk drive (HDD), a solid state drive (SSD), or a combination of these.

Note that the computer C can further include a random access memory (RAM) in which the program P is loaded at the execution of the program P and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a non-transitory tangible storage medium M which is readable by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

Further, the above-described functions of the above-described apparatuses may be realized by a single processor provided in a single computer, may be realized by causing a plurality of processors provided in a single computer to operate together, or may be realized by causing a plurality of processors provided in a plurality of corresponding computers to operate together. Further, a program for causing the above-described apparatuses to realize the above-described functions may be stored in a single memory provided in a single computer, may be stored dispersedly in a plurality of memories provided in a single computer, or may be stored dispersedly in a plurality of memories provided in a plurality of corresponding computers.

### [Additional Remark A]

The present disclosure includes the techniques described in the supplementary notes below. Note, however, that the present invention is not limited to the techniques described in the supplementary notes below, but may be altered in various ways by a skilled person within the scope of the claims.

### (Supplementary Note A1)

An information processing apparatus including:
an acquisition means for acquiring input information;
a derivation means for deriving at least one selected from the group consisting of a first response time, which is required for a first language model to generate first response information in a case where content indicated by the input information is input into the first language model, and a second response time, which is required for a second language model to generate second response information in a case where the content indicated by the input information is input into the second language model; and
a determination means for determining response content with respect to the input information with reference to the at least one selected from the group consisting of the first response time and the second response time which has been derived by the derivation means.

### (Supplementary Note A2)

The information processing apparatus described in supplementary note A1, wherein:
the derivation means further derives an allowable time from the acquisition of the input information to output of response information with respect to the input information; and
the determination means determines the response content with respect to the input information further with reference to the allowable time.

### (Supplementary Note A3)

The information processing apparatus described in supplementary note A2, wherein:
the first response time is shorter than the second response time; and
in a case where the allowable time is shorter than the first response time, the determination means includes at least one of a plurality of preset actions in the response content.

### (Supplementary Note A4)

The information processing apparatus described in supplementary note A3, wherein
in a case where the allowable time is longer than the first response time and shorter than the second response time, the determination means includes the first response information in the response content.

### (Supplementary Note A5)

The information processing apparatus described in supplementary note A4, wherein
in a case where the allowable time is longer than the first response time and the second response time, the determination means includes the second response information in the response content.

### (Supplementary Note A6)

The information processing apparatus described in any one of supplementary notes A1 to A5, wherein:
the information processing apparatus includes an execution means for executing the response content which has been determined by the determination means; and
until the second response information obtained by the second language model is acquired, the determination means and the execution means repeat (i) the determination of the response content including at least one selected from the plurality of actions and the first response information and (ii) the execution of the response content, respectively.

### (Supplementary Note A7)

The information processing apparatus described in any one of supplementary notes A1 to A6, wherein:
the response content includes an utterance;
the determination means includes a first determination means for sequentially determining, with reference to the input information sequentially acquired from at least one target, whether the at least one target and/or the information processing apparatus is/are issuing an utterance or whether neither the at least one target nor the information processing apparatus is issuing an utterance; and
the determination means determines the response content with reference to a determination result obtained by the first determination means.

### (Supplementary Note A8)

The information processing apparatus described in supplementary note A7, wherein:
the determination means includes a second determination means for sequentially determining, with reference to the input information sequentially acquired from the at least one target, whether the at least one target should issue an utterance or whether the information processing apparatus should issue an utterance; and
the determination means determines the response content further with reference to a determination result obtained by the second determination means.

### (Supplementary Note A9)

The information processing apparatus described in any one of supplementary notes A1 to A8, wherein
the determination means determines the response content with use of a response content determination model that has been trained with reference to training data which includes a plurality of sets each including an utterance issued by at least one target and a response to the utterance.

### (Supplementary Note A10)

The information processing apparatus described in supplementary note A9, wherein
the information processing apparatus includes a training means for training the response content determination model with reference to the training data.

### (Supplementary Note A11)

The information processing apparatus described in supplementary note A9 or A10, wherein
the response content determination model includes the first language model.

### (Supplementary Note A12)

The information processing apparatus described in any one of supplementary notes A1 to A11, further including
a first inference means for carrying out, with reference to the input information acquired from at least one target, inference of a feeling related to the at least one target, wherein
the determination means determines the response content further with reference to an inference result obtained by the first inference means.

### (Supplementary Note A13)

The information processing apparatus described in any one of supplementary notes A1 to A12, further including
a second inference means for carrying out, with reference to the input information acquired from at least one target, inference of content that is expected by the at least one target, wherein
the determination means determines the response content further with reference to an inference result obtained by the second inference means.

### (Supplementary Note A14)

The information processing apparatus described in any one of supplementary notes A1 to A13, further including
a third inference means for inferring, with reference to the input information acquired from at least one target, whether or not the at least one target includes a non-living body, wherein
the determination means determines the response content further with reference to an inference result obtained by the third inference means.

### (Supplementary Note A15)

An information processing apparatus including:
an acquisition means for acquiring input information from at least one target;
a first inference means for carrying out inference of a feeling related to the at least one target with reference to the input information; and
a determination means for determining response content with respect to the input information with reference to an inference result obtained by the first inference means.

### (Supplementary Note A16)

The information processing apparatus described in supplementary note A15, further including
a derivation means for deriving a response time which is required for at least one language model to generate response information in a case where content indicated by the input information is input into the at least one language model, wherein
the determination means determines the response content with respect to the input information further with reference to the response time which has been derived by the derivation means.

### (Supplementary Note A17)

The information processing apparatus described in supplementary note A15 or A16, further including
a second inference means for carrying out, with reference to the input information, inference of content that is expected by the at least one target, wherein
the determination means determines the response content further with reference to an inference result obtained by the second inference means.

### (Supplementary Note A18)

An information processing apparatus including:
an acquisition means for acquiring input information from at least one target;
an inference means for inferring, with reference to the input information, whether or not the at least one target includes a non-living body; and
a determination means for determining response content with respect to the input information with reference to an inference result obtained by the inference means.

### (Supplementary Note A19)

The information processing apparatus described in supplementary note A18, wherein
the input information includes an utterance issued by any of the at least one target.

### (Supplementary Note A20)

The information processing apparatus described in supplementary note A19, wherein
a process carried out by the inference means includes a determination process for sequentially determining, with reference to the input information sequentially acquired from the at least one target, whether at least one of the at least one target is issuing an utterance or whether none of the at least one target is issuing an utterance.

### (Supplementary Note A21)

The information processing apparatus described in supplementary note A19 or A20, wherein
the inference means carries out an inference process with use of an inference model that has been trained with reference to training data which includes an utterance issued by at least one target including a non-living body and a label attached to the utterance.

### [Additional Remark B]

The present disclosure includes the techniques described in the supplementary notes below. Note, however, that the present invention is not limited to the techniques described in the supplementary notes below, but may be altered in various ways by a skilled person within the scope of the claims.

### (Supplementary Note B1)

An information processing method including:
an acquisition process for at least one processor acquiring input information;
a derivation process for the at least one processor deriving at least one selected from the group consisting of a first response time, which is required for a first language model to generate first response information in a case where content indicated by the input information is input into the first language model, and a second response time, which is required for a second language model to generate second response information in a case where the content indicated by the input information is input into the second language model; and
a determination process for the at least one processor determining response content with respect to the input information with reference to the at least one selected from the group consisting of the first response time and the second response time which have been derived in the derivation process.

### (Supplementary Note B2)

The information processing method described in supplementary note B1, wherein:
in the derivation process, the at least one processor further derives an allowable time from the acquisition of the input information to output of response information with respect to the input information; and
in the determination process, the at least one processor determines the response content with respect to the input information further with reference to the allowable time.

### (Supplementary Note B3)

The information processing method described in supplementary note B2, wherein:
the first response time is shorter than the second response time; and
in a case where the allowable time is shorter than the first response time, the at least one processor includes, in the response content, at least one of a plurality of preset actions in the determination process.

### (Supplementary Note B4)

The information processing method described in supplementary note B3, wherein
in a case where the allowable time is longer than the first response time and shorter than the second response time, the at least one processor includes the first response information in the response content in the determination process.

### (Supplementary Note B5)

The information processing method described in supplementary note B4, wherein
in a case where the allowable time is longer than the first response time and the second response time, the at least one processor includes the second response information in the response content in the determination process.

### (Supplementary Note B6)

The information processing method described in any one of supplementary notes B1 to B5, including
an execution process for the at least one processor executing the response content which has been determined in the determination process, wherein
until the second response information obtained by the second language model is acquired, the at least one processor repeats, in the determination process and the execution process, (i) the determination of the response content including at least selected from the plurality of actions and the first response information and (ii) the execution of the response content, respectively.

### (Supplementary Note B7)

The information processing method described in any one of supplementary notes B1 to B6, wherein:
the response content includes an utterance; and
in the determination process,
the at least one processor carries out a first determination process for sequentially determining, with reference to the input information sequentially acquired from at least one target, whether the at least one target and/or the information processing apparatus is/are issuing an utterance or whether neither the at least one target nor the information processing apparatus is issuing an utterance, and
the at least one processor determines the response content with reference to a determination result obtained in the first determination process.

### (Supplementary Note B8)

The information processing method described in supplementary note B7, wherein
in the determination process,
the at least one processor carries out a second determination process for sequentially determining, with reference to the input information sequentially acquired from the at least one target, whether the at least one target should issue an utterance or whether the information processing apparatus should issue an utterance, and
the at least one processor determines the response content further with reference to a determination result obtained in the second determination process.

### (Supplementary Note B9)

The information processing method described in any one of supplementary notes B1 to B8, wherein
in the determination process, the at least one processor determines the response content with use of a response content determination model that has been trained with reference to training data which includes a plurality of sets each including an utterance issued by at least one target and a response to the utterance.

### (Supplementary Note B10)

The information processing method described in supplementary note B9, including
a training process for the at least one processor training the response content determination model with reference to the training data.

### (Supplementary Note B11)

The information processing method described in supplementary note B9 or B10, wherein
the response content determination model includes the first language model.

### (Supplementary Note B12)

The information processing method described in any one of supplementary notes B1 to B11, further including
a first inference process for the at least one processor carrying out, with reference to the input information acquired from at least one target, inference of a feeling related to the at least one target, wherein
in the determination process, the at least one processor determines the response content further with reference to an inference result obtained in the first inference process.

### (Supplementary Note B13)

The information processing method described in any one of supplementary notes B1 to B12, further including
a second inference process for the at least one processor carrying out, with reference to the input information acquired from at least one target, inference of content that is expected by the at least one target, wherein
in the determination process, the at least one processor determines the response content further with reference to an inference result obtained in the second inference process.

### (Supplementary Note B14)

The information processing method described in any one of supplementary notes B1 to B13, further including
a third inference process for the at least one processor inferring, with reference to the input information acquired from at least one target, whether or not the at least one target includes a non-living body, wherein
in the determination process, the at least one processor determines the response content further with reference to an inference result obtained in the third inference process.

### [Additional Remark C]

The present disclosure includes the techniques described in the supplementary notes below. Note, however, that the present invention is not limited to the techniques described in the supplementary notes below, but may be altered in various ways by a skilled person within the scope of the claims.

### (Supplementary Note C1)

A program for causing a computer to function as an information processing apparatus,
the program causing the computer to function as:
an acquisition means for acquiring input information;
a derivation means for deriving at least one selected from the group consisting of a first response time, which is required for a first language model to generate first response information in a case where content indicated by the input information is input into the first language model, and a second response time, which is required for a second language model to generate second response information in a case where the content indicated by the input information is input into the second language model; and
a determination means for determining response content with respect to the input information with reference to the at least one selected from the group consisting of the first response time and the second response time which has been derived by the derivation means.

### (Supplementary Note C2)

The program described in supplementary note C1, wherein:
the derivation means further derives an allowable time from the acquisition of the input information to output of response information with respect to the input information; and
the determination means determines the response content with respect to the input information further with reference to the allowable time.

### (Supplementary Note C3)

The program described in supplementary note C2, wherein:
the first response time is shorter than the second response time; and
in a case where the allowable time is shorter than the first response time, the determination means includes at least one of a plurality of preset actions in the response content.

### (Supplementary Note C4)

The program described in supplementary note C3, wherein
in a case where the allowable time is longer than the first response time and shorter than the second response time, the determination means includes the first response information in the response content.

### (Supplementary Note C5)

The program described in supplementary note C4, wherein
in a case where the allowable time is longer than the first response time and the second response time, the determination means includes the second response information in the response content.

### (Supplementary Note C6)

The program described in any one of supplementary notes C1 to C5, causing the computer to function as an execution means for executing the response content which has been determined by the determination means, wherein until the second response information obtained by the second language model is acquired, the determination means and the execution means repeat (i) the determination of the response content including at least one selected from the plurality of actions and the first response information and (ii) the execution of the response content, respectively.

### (Supplementary Note C7)

The program described in any one of supplementary notes C1 to C6, wherein:
the response content includes an utterance;
the determination means includes a first determination means for sequentially determining, with reference to the input information sequentially acquired from at least one target, whether the at least one target and/or the information processing apparatus is/are issuing an utterance or whether neither the at least one target nor the information processing apparatus is issuing an utterance; and
the determination means determines the response content with reference to a determination result obtained by the first determination means.

### (Supplementary Note C8)

The program described in supplementary note C7, wherein:
the determination means includes a second determination means for sequentially determining, with reference to the input information sequentially acquired from the at least one target, whether the at least one target should issue an utterance or whether the information processing apparatus should issue an utterance; and
the determination means determines the response content further with reference to a determination result obtained by the second determination means.

### (Supplementary Note C9)

The program described in any one of supplementary notes C1 to C8, wherein
the determination means determines the response content with use of a response content determination model that has been trained with reference to training data which includes a plurality of sets each including an utterance issued by at least one target and a response to the utterance.

### (Supplementary Note C10)

The program described in supplementary note C9, causing the computer to function as a training means for training the response content determination model with reference to the training data.

### (Supplementary Note C11)

The program described in supplementary note C9 or C10, wherein
the response content determination model includes the first language model.

### (Supplementary Note C12)

The program described in any one of supplementary notes C1 to C11, causing the computer to further function as
a first inference means for carrying out, with reference to the input information acquired from at least one target, inference of a feeling related to the at least one target, wherein
the determination means determines the response content further with reference to an inference result obtained by the first inference means.

### (Supplementary Note C13)

The program described in any one of supplementary notes C1 to C12, causing the computer to further function as
a second inference means for carrying out, with reference to the input information acquired from at least one target, inference of content that is expected by the at least one target, wherein
the determination means determines the response content further with reference to an inference result obtained by the second inference means.

### (Supplementary Note C14)

The program described in any one of supplementary notes C1 to C13, causing the computer to further function as
a third inference means for inferring, with reference to the input information acquired from at least one target, whether or not the at least one target includes a non-living body, wherein
the determination means determines the response content further with reference to an inference result obtained by the third inference means.

### [Additional Remark D]

The present disclosure includes the techniques described in the supplementary notes below. Note, however, that the present invention is not limited to the techniques described in the supplementary notes below, but may be altered in various ways by a skilled person within the scope of the claims.

### (Supplementary Note D1)

An information processing apparatus including at least one processor, the at least one processor carrying out:
an acquisition process for acquiring input information;
a derivation process for deriving at least one selected from the group consisting of a first response time, which is required for a first language model to generate first response information in a case where content indicated by the input information is input into the first language model, and a second response time, which is required for a second language model to generate second response information in a case where the content indicated by the input information is input into the second language model; and
a determination process for determining response content with respect to the input information with reference to the at least one selected from the group consisting of the first response time and the second response time which has been derived in the derivation process.

Note that the information processing apparatus may further include a memory. Further, the memory may store a program for causing the at least one processor to carry out each of the above-described processes.

### (Supplementary Note D2)

The information processing apparatus described in supplementary note D1, wherein:
in the derivation process, the at least one processor further derives an allowable time from the acquisition of the input information to output of response information with respect to the input information; and
in the determination process, the at least one processor determines the response content with respect to the input information further with reference to the allowable time.

### (Supplementary Note D3)

The information processing apparatus described in supplementary note D2, wherein:
the first response time is shorter than the second response time; and
in a case where the allowable time is shorter than the first response time, the at least one processor includes, in the response content, at least one of a plurality of preset actions in the determination process.

### (Supplementary Note D4)

The information processing apparatus described in supplementary note D3, wherein in a case where the allowable time is longer than the first response time and shorter than the second response time, the at least one processor includes the first response information in the response content in the determination process.

### (Supplementary Note D5)

The information processing apparatus described in supplementary note D4, wherein
in a case where the allowable time is longer than the first response time and the second response time, the at least one processor includes the second response information in the response content in the determination process.

### (Supplementary Note D6)

The information processing apparatus described in any one of supplementary notes D1 to D5, wherein:
the at least one processor carries out an execution process for executing the response content which has been determined in the determination process; and
until the second response information obtained by the second language model is acquired, the at least one processor repeats, in the determination process and the execution process, (i) the determination of the response content including at least one selected from the plurality of actions and the first response information and (ii) the execution of the response content, respectively.

### (Supplementary Note D7)

The information processing apparatus described in any one of supplementary notes D1 to D6, wherein:
the response content includes an utterance; and
in the determination process,
the at least one processor carries out a first determination process for sequentially determining, with reference to the input information sequentially acquired from at least one target, whether the at least one target and/or the information processing apparatus is/are issuing an utterance or whether neither the at least one target nor the information processing apparatus is issuing an utterance, and
the at least one processor determines the response content reference with to a determination result obtained in the first determination process.

### (Supplementary Note D8)

The information processing apparatus described in supplementary note D7, wherein
in the determination process,
the at least one processor carries out a second determination process for sequentially determining, with reference to the input information sequentially acquired from the at least one target, whether the at least one target should issue an utterance or whether the information processing apparatus should issue an utterance, and
the at least one processor determines the response content further with reference to a determination result obtained in the second determination process.

### (Supplementary Note D9)

The information processing apparatus described in any one of supplementary notes D1 to D8, wherein
in the determination process, the at least one processor determines the response content with use of a response content determination model that has been trained with reference to training data which includes a plurality of sets each including an utterance issued by at least one target and a response to the utterance.

### (Supplementary Note D10)

The information processing apparatus described in supplementary note D9, wherein
the at least one processor carries out a training process for training the response content determination model with reference to the training data.

### (Supplementary Note D11)

The information processing apparatus described in supplementary note D9 or D10, wherein
the response content determination model includes the first language model.

### (Supplementary Note D12)

The information processing apparatus described in any one of supplementary notes D1 to D11, wherein:
the at least one processor further carries out a first inference process for carrying out, with reference to the input information acquired from at least one target, inference of a feeling related to the at least one target; and in the determination process, the at least one processor determines the response content further with reference to an inference result obtained in the first inference process.

### (Supplementary Note D13)

The information processing apparatus described in any one of supplementary notes D1 to D12, wherein:
the at least one processor further carries out a second inference process for carrying out, with reference to the input information acquired from at least one target, inference of content that is expected by the at least one target; and
in the determination process, the at least one processor determines the response content further with reference to an inference result obtained in the second inference process.

### (Supplementary Note D14)

The information processing apparatus described in any one of supplementary notes D1 to D13, wherein:
the at least one processor further carries out a third inference process for inferring, with reference to the input information acquired from at least one target, whether or not the at least one target includes a non-living body; and
in the determination process, the at least one processor determines the response content further with reference to an inference result obtained in the third inference process.

### [Additional Remark E]

The present disclosure includes the techniques described in the supplementary notes below. Note, however, that the present invention is not limited to the techniques described in the supplementary notes below, but may be altered in various ways by a skilled person within the scope of the claims.

### (Supplementary Note E1)

A non-transitory storage medium storing a program for causing a computer to function as an information processing apparatus,
the program causing the computer to carry out:
an acquisition process for acquiring input information;
a derivation process for deriving at least one selected from the group consisting of a first response time, which is required for a first language model to generate first response information in a case where content indicated by the input information is input into the first language model, and a second response time, which is required for a second language model to generate second response information in a case where the content indicated by the input information is input into the second language model; and
a determination process for determining response content with respect to the input information with reference to the at least one selected from the group consisting of the first response time and the second response time which has been derived in the derivation process.

### REFERENCE SIGNS LIST

1, 2, 2A, 2B, 3, 4: information processing apparatus
11, 21, 21A, 21B, 31, 41: acquisition unit
12, 22, 32, 42: derivation unit
13, 23, 23A, 23B, 33, 43: determination unit
24, 24A: first inference unit
25: second inference unit
26, 26B: third inference unit
27, 27A, 27B, 37, 47: execution unit
48: training unit
331: first determination unit
332: second determination unit
LM: language model

1. An information processing apparatus comprising at least one processor, the at least one processor carrying out:
an acquisition process for acquiring input information;
a derivation process for deriving at least one selected from the group consisting of a first response time, which is required for a first language model to generate first response information in a case where content indicated by the input information is input into the first language model, and a second response time, which is required for a second language model to generate second response information in a case where the content indicated by the input information is input into the second language model; and
a determination process for determining response content with respect to the input information with reference to the at least one selected from the group consisting of the first response time and the second response time which has been derived in the derivation process.

2. The information processing apparatus according to claim 1, wherein:
in the derivation process, the at least one processor further derives an allowable time from the acquisition of the input information to output of response information with respect to the input information; and
in the determination process, the at least one processor determines the response content with respect to the input information further with reference to the allowable time.

3. The information processing apparatus according to claim 2, wherein:
the first response time is shorter than the second response time; and
in a case where the allowable time is shorter than the first response time, the at least one processor includes, in the response content, at least one of a plurality of preset actions in the determination process.

4. The information processing apparatus according to claim 1, wherein:
the response content includes an utterance; and
in the determination process,
the at least one processor carries out a first determination process for sequentially determining, with reference to the input information sequentially acquired from at least one target, whether the at least one target and/or the information processing apparatus is/are issuing an utterance or whether neither the at least one target nor the information processing apparatus is issuing an utterance, and
the at least one processor determines the response content with reference to a determination result obtained in the first determination process.

5. The information processing apparatus according to claim 4, wherein
in the determination process,
the at least one processor carries out a second determination process for sequentially determining, with reference to the input information sequentially acquired from the at least one target, whether the at least one target should issue an utterance or whether the information processing apparatus should issue an utterance, and
the at least one processor determines the response content further with reference to a determination result obtained in the second determination process.

6. The information processing apparatus according to claim 1, wherein:
the at least one processor further carries out a first inference process for carrying out, with reference to the input information acquired from at least one target, inference of a feeling related to the at least one target; and
in the determination process, the at least one processor determines the response content further with reference to an inference result obtained in the first inference process.

7. The information processing apparatus according to claim 1, wherein:
the at least one processor further carries out a second inference process for carrying out, with reference to the input information acquired from at least one target, inference of content that is expected by the at least one target; and
in the determination process, the at least one processor determines the response content further with reference to an inference result obtained in the second inference process.

8. The information processing apparatus according to claim 1, wherein:
the at least one processor further carries out a third inference process for inferring, with reference to the input information acquired from at least one target, whether or not the at least one target includes a non-living body; and
in the determination process, the at least one processor determines the response content further with reference to an inference result obtained in the third inference process.

9. An information processing method comprising:
an acquisition process for at least one processor acquiring input information;
a derivation process for the at least one processor deriving at least one selected from the group consisting of a first response time, which is required for a first language model to generate first response information in a case where content indicated by the input information is input into the first language model, and a second response time, which is required for a second language model to generate second response information in a case where the content indicated by the input information is input into the second language model; and
a determination process for the at least one processor determining response content with respect to the input information with reference to the at least one selected from the group consisting of the first response time and the second response time which has been derived in the derivation process.

10. A non-transitory storage medium storing a program for causing a computer to function as an information processing apparatus,
the program causing the computer to carry out:
an acquisition process for acquiring input information;
a derivation process for deriving at least one selected from the group consisting of a first response time, which is required for a first language model to generate first response information in a case where content indicated by the input information is input into the first language model, and a second response time, which is required for a second language model to generate second response information in a case where the content indicated by the input information is input into the second language model; and
a determination process for determining response content with respect to the input information with reference to the at least one selected from the group consisting of the first response time and the second response time which has been derived in the derivation process.
